(19) United States
(12) Patent Application Publication
(10) Pub. No.: US 2024/0214988 A1
(43) Pub. Date: Jun. 27, 2024

(54) METHOD AND APPARATUS FOR MULTICAST SESSION SIGNALING IN WIRELESS COMMUNICATION SYSTEM

(71) Applicant: SAMSUNG ELECTRONICS CO., LTD., Suwon-si, Gyeonggi-do (KR)

(72) Inventors: Vinay Kumar SHRIVASTAVA, Bangalore (IN); Sangkyu BAEK, Suwon-si (KR); Himke VAN DER VELDE, Zwolle (NL)

(21) Appl. No.: 18/557,192

(22) PCT Filed: Apr. 27, 2022
(86) PCT No.: PCT/KR2022/006024

§ 371 Date: Oct. 25, 2023

(30) Foreign Application Priority Data
Apr. 27, 2021 (IN) 202141019437
Apr. 14, 2022 (IN) 202141019437

(51) Int. Cl. H04W 68/02; H04L 12/18; H04W 76/27

(52) U.S. Cl. CPC H04W 68/02; H04L 12/185; H04L 12/189; H04W 76/27

(57) ABSTRACT

Embodiments herein provide method for multicast session notification signalling and procedure in wireless network (1000) by UE (100). In an embodiment, the method includes receiving a signal related with a multicast and broadcast service (MBS) session in a radio resource control (RRC) connected state; in case that the UE (100) transits from the RRC connected state to one of a RRC idle state or a RRC inactive state and determines to join in at least one MBS session, monitoring a message for a group notification related with the at least one MBS session on a physical downlink control channel (PDCCH); based on a detection of the paging message, identifying a temporary mobile group identity (TMGI) indicating one of the at least one MBS session included in the paging message; and forwarding the identified TMGI to an upper layer.

### TECHNICAL FIELD

The present invention relates to a wireless communication system, in general, and in particular, to a multicast session notification signalling and procedure of Multicast Broadcast Services (MBS) for New Radio (NR), in a 5th generation Radio Access Technology (RAT).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

In general, a new radio multicast broadcast services (NR MBS) service includes multicast services, for which a network transfers common user data that is intended to be received only by a specific group of User Equipment's (UEs) which have joined the concerned multicast group. Broadcast services, for which the network transfers common user data that can be received by all the UEs interested to receive the service. In this the network may provide MBS services in a limited part of the network and coverage area of MBS services can be one cell or larger.

Particularly, MBS/multicast services/sessions can be in different services states e.g., configured, started, activated, deactivated, stopped, released, deconfigured. Therefore, there is a need to notify the UE or UE-group about a service state or change of the service state as the UEs may be in different radio resource control (RRC) states (e.g., RRC_IDLE, RRC_INACTIVE, RRC_CONNECTED) and is not aware about this. Furthermore, different approaches for this MBS/multicast session notification signalling may be needed given the different RRC states for the UE and/or different signalling support by a RAN (Radio Access Node) and/or efficiency/flexibility of the signalling approach and so on. Different approaches may have different advantages and/or deficiencies.

Thus, it is desired to address the above mentioned issues with MBS/multicast notification and provide suitable approach (es) and address any disadvantages or other shortcomings or at least provide a useful alternative.

### Solution to Problem

The principal object of the embodiments herein is to provide a method, a UE and a network apparatus for multicast session notification signalling and procedure in 5th generation (5G) New Radio (NR).

Another object of the embodiments herein is to provide a multicast session notification with unicast paging, group paging with unicast paging occasions (POs), group paging with common POs, MCCH based notification for a UE in an RRC_IDLE/RRC_INACTIVE states.

Another object of the embodiments herein is to provide multicast session notification implicitly with a dedicated RRC signalling for the UE in an RRC_CONNECTED state.

Another object of the embodiments herein is to handle RACH congestion for a large number of UEs belonging to a multicast session.

Another object of the embodiments herein is to Paging Early Indication (PEI) handling by the UEs.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1a illustrates MBS delivery from a Core Network (CN) to RAN and UE;

FIG. 1b illustrating an example of protocol stack for MBS in 5G New Radio (NR);

FIG. 1c illustrating an example of multicast session state and state transition;

FIG. 1d illustrating an example of MCCH transmission;

FIG. 2a illustrates overview of a wireless network for a multicast session notification signalling and procedure, according to the embodiments as disclosed herein;

FIG. 2b illustrates various hardware elements of a UE, according to the embodiments as disclosed herein;

FIG. 2c illustrates various hardware elements of a network apparatus, according to the embodiments as disclosed herein;

FIG. 3 is a flow chart illustrating a method, implemented by the UE, for the multicast session notification signalling and procedure in the wireless network, according to the embodiments as disclosed herein;

FIG. 4 is a flow chart illustrating a method, implemented by the network apparatus, for the multicast session notification signalling and procedure in the wireless network, according to the embodiments as disclosed herein;

FIG. 5 is a sequence diagram illustrating a method for the multicast session notification signalling and procedure in the wireless network based on a group Notification in an RRC_IDLE state using unicast POs, according to the embodiments as disclosed herein;

FIG. 6 is a sequence diagram illustrating a method for the multicast session notification signalling and procedure in the wireless network based on the group notification in an RRC_INACTIVE state using unicast POs, according to the embodiments as disclosed herein;

FIG. 7 is a flow chart illustrating a method, implemented by the UE, for the multicast session notification signalling and procedure in the wireless network when the UE receives a RRC release or a RRC release with suspend configuration or has data Inactivity timer expiry and transits to RRC_IDLE or RRC_INACTIVE state from RRC_CONNECTED state, according to the embodiments as disclosed herein;

FIG. 8 is a sequence diagram illustrating a method for the multicast session notification signalling and procedure in the wireless network based on a group notification in an RRC_IDLE state using common POs, according to the embodiments as disclosed herein;

FIG. 9 is a sequence diagram illustrating a method for the multicast session notification signalling and procedure in the wireless network based on the group notification in an RRC_INACTIVE state using common POs, according to the embodiments as disclosed herein;

FIG. 10 is a sequence diagram illustrating a method for the multicast session notification signalling and procedure in the wireless network based on the group notification in RRC_IDLE state using MCCH change notification and/or MCCH, according to the embodiments as disclosed herein;

FIG. 11 is a sequence diagram illustrating a method for the multicast session notification signalling and procedure in the wireless network based on the group notification in the RRC_INACTIVE state using the MCCH change notification and/or MCCH, according to the embodiments as disclosed herein;

FIG. 12 is a sequence diagrams illustrating a method for the multicast session notification signalling and procedure in the wireless network based on the group notification in an RRC_CONNCTED state, according to the embodiments as disclosed herein;

FIG. 13 is a sequence diagrams illustrating a method for the multicast session notification signalling and procedure in the wireless network based on the group notification in an RRC_CONNCTED state, according to the embodiments as disclosed herein;

FIG. 14 is a sequence diagram illustrating a method for the multicast session notification signalling and procedure in the wireless network based on a multicast session configuration store/restore in an RRC_IDLE state or an RRC_INACTIVE state, according to the embodiments as disclosed herein;

FIG. 15 is a sequence diagram illustrating a method for the multicast session notification signalling and procedure in the wireless network based on a random access back-off mechanism in the RRC_IDLE state or the RRC_INACTIVE state, according to the embodiments as disclosed herein;

FIG. 16 is a flow chart illustrating a method, implemented by the UE, for the multicast session notification signalling and procedure in the wireless network based on a PEI indicating a presence of paging for the unicast and/or one or more multicast group notification, according to the embodiments as disclosed herein; and

FIG. 17 is a flow chart illustrating a method, implemented by the UE, for the multicast session notification signalling and procedure in the wireless network based on the PEI indicating presence of paging for the unicast, according to the embodiments as disclosed herein.

### BEST MODE FOR CARRYING OUT THE INVENTION

Accordingly, the embodiment herein is to provide a method for multicast session notification signalling and procedure in a wireless network. The method includes establishing, by a UE in the wireless network, a multicast session with a network apparatus. The multicast session is associated with an MBS session Identifier (ID) or a Temporary Mobile Group Identity (TMGI). Further, the method includes detecting, by the UE, that the UE transits from a Radio Resource Control (RRC) connected state to one of a RRC idle state or a RRC inactive state. Further, the method includes determining, by the UE, whether the UE has joined at least one multicast session which is non-activated in response detecting that the UE is in one of the RRC idle state or the RRC inactive state. In an embodiment, a non-activated multicast session includes at least one of a multicast session which is not yet activated and a multicast session which has been deactivated after activation. In an embodiment, the method includes monitoring for paging for a group notification message for activation of the multicast session associated with the MBS session ID or the TMGI through at least one of unicast Paging Occasions (POs), group paging with common POs, and a MCCH change notification in response to determining that the UE has joined the at least one multicast session which is non-activated. In another embodiment, the method includes skipping monitoring for paging for a group notification message for activation of the multicast session associated with the MBS session ID or the TMGI on at least one of unicast POs, group paging with common POs, and a Multicast Control Channel (MCCH) change notification in response to determining that the UE has not joined the at least one multicast session which is non-activated.

In an embodiment, the UE includes a transceiver; and a processor coupled with the transceiver and configured to: receive a signal related with a multicast and broadcast service (MBS) session in a radio resource control (RRC) connected state, in case that the UE transits from the RRC connected state to one of a RRC idle state or a RRC inactive state and determines to join in at least one MBS session, monitor a paging message for a group notification related with the at least one MBS session on a physical downlink control channel (PDCCH), based on a detection of the paging message, identify a temporary mobile group identity (TMGI) indicating one of the at least one MBS session included in the paging message, and forward the identified TMGI to an upper layer.

In an embodiment, the base station includes a transceiver; and a processor coupled with the transceiver and configured to: transmit a signal related with a multicast and broadcast service (MBS) session to a user equipment (UE) in a radio resource control (RRC) connected state, and in case that the UE is transited from the RRC connected state to one of a RRC idle state or a RRC inactive state, transmit a paging message for a group notification to join at least one MBS session, on a physical downlink control channel (PDCCH), wherein based on a detection of the paging message at the UE, a temporary mobile group identity (TMGI) indicating one of the at least one MBS session included in the paging message is forwarded to an upper layer of the UE.

In an embodiment, a method performed by the UE includes receiving a signal related with a multicast and broadcast service (MBS) session in a radio resource control (RRC) connected state; in case that the UE transits from the RRC connected state to one of a RRC idle state or a RRC inactive state and determines to join in at least one MBS session, monitoring a paging message for a group notification related with the at least one MBS session on a physical downlink control channel (PDCCH); based on a detection of the paging message, identifying a temporary mobile group identity (TMGI) indicating one of the at least one MBS session included in the paging message; and forwarding the identified TMGI to an upper layer.

In an embodiment, a method performed by a base station includes: transmitting a signal related with a multicast and broadcast service (MBS) session to the UE in a radio resource control (RRC) connected state; and in case that the UE is transited from the RRC connected state to one of a RRC idle state or a RRC inactive state, transmitting a paging message for a group notification to join at least one MBS session, on a physical downlink control channel (PDCCH), wherein based on a detection of the paging message at the UE, a temporary mobile group identity (TMGI) indicating one of the at least one MBS session included in the paging message is forwarded to an upper layer of the UE.

In an embodiment, detecting, by the UE, that the UE transits from the RRC connected state to one of the RRC idle state or the RRC inactive state includes receiving, by the UE, a RRC reconfiguration with MBS Radio Bearer (MRB) release conveying deactivation of the multicast session associated with the MBS session ID or the TMGI, and one of a RRC release and a RRC release with suspend configuration, and transitioning, by the UE, from the connected state to one of the idle state or the inactive state or has data inactivity timer expiry.

In an embodiment, detecting, by the UE, that the UE transits from the RRC connected state to one of the RRC idle state or the RRC inactive state includes receiving, by the UE, a group notification message from the network apparatus for deactivation of the multicast session associated with the MBS session ID or the TMGI, and one of a RRC release and a RRC release with suspend configuration, wherein the group notification message for deactivation of the multicast session is received on at least one of unicast POs, group paging with common POs, and a MCCH change notification, and transitioning, by the UE, from the RRC connected state to one of the RRC idle state or the RRC inactive state.

In an embodiment, monitoring for paging for the group notification message for activation of the multicast session associated with the MBS session ID or the TMGI through unicast POs includes monitoring same paging frame (PF) and PO as that of unicast paging, receiving and decoding paging message with Paging-Radio Network Temporary Identifier (P-RNTI), parsing and determining presence or absence of the MBS session ID or the TMGI in the pagingGroupList in the paging message for at least one of the multicast session associated with UE which UE has joined and is non-activated, wherein pagingGroupList is a list of MBS session IDs or TMGIs of multicast sessions which are activated, and detecting activation of the MBS session in response to determining the presence of MBS session ID or the TMGI in the pagingGroupList in the paging message for at least one of the multicast session associated with UE which UE has joined and is non-activated.

In an embodiment, monitoring for paging for a group notification message for activation of the multicast session associated with the MBS session ID or the TMGI through group paging with common POs comprises monitoring a common paging frame (PF) and PO by all UEs that is different than that of unicast PF and PO of the respective UEs, receiving and decoding paging message with one of Paging-Radio Network Temporary Identifier (P-RNTI) or the Group-Radio Network Temporary Identifier (G-RNTI) of the concerned MBS session, parsing and determining presence or absence of MBS session ID or the TMGI in the pagingGroupList in the paging message for at least one of the multicast session associated with UE which UE has joined and is non-activated, wherein pagingGroupList is a list of MBS session IDs or TMGIs of multicast sessions which are activated, and detecting activation of the MBS session in response to determining the presence of MBS session ID or the TMGI in the pagingGroupList in the paging message for at least one of the multicast session associated with UE which UE has joined and is non-activated.

In an embodiment, monitoring for paging for a group notification message for activation of the multicast session associated with the MBS session ID or the TMGI through a MCCH change notification includes monitoring a MCCH change notification on downlink control information (DCI) on the PDCCH, determining presence or absence of a MCCH change notification that indicates the change of the activation list of at least one MBS session in the MCCH, and receiving and determining if the MCCH consists activation for at least one MBS session associated with UE which UE has joined and is non-activated, in response to determining the presence of a MCCH change notification.

In an embodiment, the method includes receiving, by the UE from the network apparatus in the wireless network, the group notification message for activation of the multicast session associated with the MBS session ID or the TMGI on at least one of the unicast POs, the group paging with common POs, and the MCCH change notification. Further, the method includes forwarding, by the UE, to an upper layer the MBS session ID or the TMGI for activation of the multicast session in response to receiving the group notification message for activation of the multicast session associated with the MBS session ID or the TMGI. Further, the method includes stop monitoring, by the UE, paging for the group notification message for activation of the multicast session associated with the MBS session ID or the TMGI on at least one of unicast POs, the group paging with common POs, and the MCCH change notification. Further, the method includes initiating, by the UE, a RRC connection setup or a RRC resume procedure based on the RRC idle state or the RRC inactive state. Further, the method includes transitioning, by UE, the UE from the RRC idle state or the RRC inactive state to the RRC connected state. Further, the method includes receiving, by the UE, a RRC reconfiguration with a configuration for the activated multicast session from the network apparatus.

In an embodiment, the method includes receiving, by the UE from the network apparatus in the wireless network, the group notification message for releasing the multicast session associated with the MBS session ID or the TMGI on at least one of the unicast POs, the group paging with common POs, and the MCCH change notification. Further, the method includes releasing, by the UE, the multicast session. Further, the method includes stop monitoring, by the UE, paging for the group notification message for activation of the multicast session associated with the MBS session ID or the TMGI on at least one of unicast POs, the group paging with common POs, and the MCCH change notification.

In an embodiment, the method further comprises storing by the UE a configuration of the multicast session before transitioning from the RRC connected state to one of the RRC idle state or the RRC inactive state.

In an embodiment, the method comprises receiving, by the UE from the network apparatus in the wireless network, the group notification message for activation of the multicast session associated with the MBS session ID or the TMGI on at least one of the unicast POs, the group paging with common POs, and the MCCH change notification. Further, the method comprises forwarding, by the UE, to an upper layer the MBS session ID or the TMGI for activation of the multicast session in response to receiving the group notification message for activation of the multicast session associated with the MBS session ID or the TMGI. Further, the method comprises stop monitoring, by the UE, paging for the group notification message for activation of the multicast session associated with the MBS session ID or the TMGI on at least one of unicast POs, the group paging with common POs, and the MCCH change notification. Further, the method comprises initiating, by the UE, a RRC connection setup or a RRC resume procedure based on the UE is in the RRC idle state or the RRC inactive state. Further, the method comprises transitioning, by UE, the UE from one of the RRC idle state or the RRC inactive state to the RRC connected state. Further, the method comprises restoring, by the UE, the multicast session based on the stored configuration of the multicast session.

In an embodiment, the method includes applying, by the UE, a randomization for an access attempt by the UE for back-off or re-attempting the access to the multicast session.

In an embodiment, the method includes determining, by the UE, whether a Paging Early Indication (PEI) indicates presence of the paging. Further, the method includes performing, by the UE, one of: receiving, by the UE, the paging irrespective to determining that the PEI indicates presence or the PEI does not indicate presence of the paging when UE has joined at least one MBS session which is non-activated, receiving, by the UE, the paging in response to determining that the PEI indicates presence of the paging and UE has not joined at least one MBS session which is non-activated, and skipping, by the UE, the reception of the paging in response to determining that the PEI does not indicate presence of the paging and UE has not joined at least one MBS session which is non-activated.

In an embodiment, the method includes determining, by the UE, whether the group notification message for the MBS session comprises or pertains to an access category and at least one access identity. Further, the method includes performing, by the UE, one of: applying a Unified Access Control (UAC) mechanism for the MBS session to establish or resume a RRC connection with the network apparatus in response to determining that the group notification message for the MBS session comprises or pertains to the access category and the at least one access identity, and establish or resume a RRC connection with the network apparatus without applying the UAC mechanism for the MBS session in response to determining that the group notification message for the MBS session does not comprise or pertain to the access category and the at least one access identity.

In an embodiment, the method includes receiving, by the UE, a congestion status for the MBS session broadcasted by the network apparatus, wherein the congestion status is broadcasted in one of system information block, MCCH information message and a paging message. Further, the method includes establishing or resuming, by the UE, a RRC connection with the network apparatus when the congestion status for the MBS session is not indicated. Further, the method includes skipping, by the UE, establish or resume of a RRC connection with the network apparatus when the congestion status for the MBS session is indicated.

In an embodiment, the method includes storing by the UE a configuration of the multicast session before transitioning from the RRC connected state to one of the RRC idle state or the RRC inactive state.

In an embodiment, the method includes receiving, by the UE from the network apparatus in the wireless network, the group notification message for activation of the multicast session associated with the MBS session ID or the TMGI on at least one of the unicast POs, the group paging with common POs, and the MCCH change notification. Further, the method includes applying, by the UE, the stored configuration. Further, the method includes resuming, by the UE, receiving MBS service in one of the RRC idle state or the RRC inactive state.

In an embodiment, the method includes sending, by the UE, message indicating a capability of the UE, wherein the message comprises at least one of: a support for MBS in a RRC state or multiple RRC states of the UE, a support for MBS notification approach or approaches of the UE, a support for one or multiple Bandwidth Parts (BWPs) simultaneously or not, a support for parallel reception for unicast and MBS and related approach comprising at least one of Time Division Multiplexing (TDM), Frequency Division Multiplexing (FDM), Carrier aggregation, and dual connectivity, and a support for simultaneous reception of one or more G-RNTIs/G-CS-RNTIs. The message is one of a UE capability information message, a UE assistance information message, a RRC Connection request message, a RRC Resume request message, a RRC setup complete message, and a MBS interest indication message.

Accordingly, the embodiment herein is to provide a method for multicast session notification signaling and procedure in a wireless network. The method includes detecting, by a network apparatus in the wireless network, a multicast session with a UE, wherein the multicast session associated with an MBS session ID or a TMGI. Further, the method includes sending, by the network apparatus, one of: a RRC reconfiguration with a MRB release conveying deactivation of the multicast session associated with the MBS session ID or the TMGI, and a group notification message to the UE for deactivation of the multicast session associated with the MBS session ID or the TMGI on at least one of unicast POs, group paging with common POs, and a MCCH change notification. Further, the method includes detecting, by the network apparatus, that the UE is transitioned from a RRC connected state to one of a RRC idle state or a RRC inactive state. Further, the method includes determining, by the network apparatus, that the UE (100) has joined at least one multicast session which is non-activated in response to detecting that the UE is in one of the RRC idle state or the RRC inactive state. Further, the method includes sending, by the network apparatus, a group notification message to the UE for activation of the multicast session associated with the MBS session ID or the TMGI on at least one of unicast POs, group paging with common POs, and a MCCH change notification. Further, the method includes performing, by the network apparatus, a RRC connection setup or a RRC resume procedure to transition the UE from one of the RRC idle state and the RRC inactive state to the RRC connected state. Further, the method includes sending, by the network apparatus, a RRC reconfiguration with a configuration for the activated multicast session to the UE.

Accordingly, the embodiment herein is to provide a UE for multicast session notification signalling and procedure in a wireless network. The UE includes a multicast session notification handler coupled with a processor and a memory. The multicast session notification handler is configured to establish a multicast session with a network apparatus. The multicast session is associated with an MBS session ID or a TMGI. The multicast session notification handler is configured to detect that the UE transits from a RRC connected state to one of a RRC idle state or a RRC inactive state. The multicast session notification handler is configured to determine whether the UE has joined at least one multicast session which is non-activated in response detecting that the UE is in one of the RRC idle state or the RRC inactive state. In an embodiment, the multicast session notification handler is configured to monitor for paging for a group notification message for activation of the multicast session associated with the MBS session ID or the TMGI through at least one of unicast POs, group paging with common POs, and a MCCH change notification in response to determining that the UE has joined the at least one multicast session which is non-activated. In another embodiment, the multicast session notification handler is configured to skip monitoring for paging for a group notification message for activation of the multicast session associated with the MBS session ID or the TMGI on at least one of unicast POs, group paging with common POs, and a MCCH change notification in response to determining that the UE has not joined the at least one multicast session which is non-activated.

Accordingly, the embodiment herein is to provide a network apparatus for multicast session notification signalling and procedure in a wireless network. The network apparatus includes a multicast session notification handler coupled with a processor and a memory. The multicast session notification handler is configured to detect a multicast session with a UE, where the multicast session associated with an MBS session ID or a TMGI. Further, the multicast session notification handler is configured to send one of: a RRC reconfiguration with a MRB release conveying deactivation of the multicast session associated with the MBS session ID or the TMGI, and a group notification message to the UE for deactivation of the multicast session associated with the MBS session ID or the TMGI on at least one of unicast POs, group paging with common POs, and a MCCH change notification. The multicast session notification handler is configured to detect that the UE is transitioned from a connected state to one of an idle state or an inactive state. Further, the multicast session notification handler is configured to determine that the UE has joined at least one multicast session which is non-activated in response to detecting that the UE is in one of the RRC idle state or the RRC inactive state. Further, the multicast session notification handler is configured to send a group notification message to the UE for activation of the multicast session associated with the MBS session ID or the TMGI on at least one of unicast POs, group paging with common POs, and a MCCH change notification. The multicast session notification handler is configured to perform a RRC connection setup or a RRC resume procedure to transition the UE from one of the RRC idle state and the RRC inactive state to the RRC connected state. Further, the multicast session notification handler is configured to send a RRC reconfiguration with a configuration for the activated multicast session to the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In general, a new radio multicast broadcast services (NR MBS) service includes multicast services, for which a network transfers common user data that is intended to be received only by a specific group of User Equipment's (UEs) which have joined the concerned multicast group. Broadcast services, for which the network transfers common user data that can be received by all the UEs interested to receive the service. In this the network may provide MBS services in a limited part of the network and coverage area of MBS services can be one cell or larger.

Particularly, MBS/multicast services/sessions can be in different services states e.g., configured, started, activated, deactivated, stopped, released, deconfigured. Therefore, there is a need to notify the UE or UE-group about a service state or change of the service state as the UEs may be in different radio resource control (RRC) states (e.g., RRC_IDLE, RRC_INACTIVE, RRC_CONNECTED) and is not aware about this. Furthermore, different approaches for this MBS/multicast session notification signalling may be needed given the different RRC states for the UE and/or different signalling support by a RAN (Radio Access Node) and/or efficiency/flexibility of the signalling approach and so on. Different approaches may have different advantages and/or deficiencies.

Thus, it is desired to address the above mentioned issues with MBS/multicast notification and provide suitable approach (es) and address any disadvantages or other shortcomings or at least provide a useful alternative.

Accordingly, the embodiment herein is to provide a method for multicast session notification signalling and procedure in a wireless network. The method includes establishing, by a UE in the wireless network, a multicast session with a network apparatus. The multicast session is associated with an MBS session ID or a TMGI. Further, the method includes detecting, by the UE, that the UE transits from a RRC connected state to one of a RRC idle state or a RRC inactive state. Further, the method includes determining, by the UE, whether the UE has joined at least one multicast session which is non-activated in response detecting that the UE is in one of the RRC idle state or the RRC inactive state. In an embodiment, a non-activated multicast session includes at least one of a multicast session which is not yet activated and a multicast session which has been deactivated after activation. In an embodiment, the method includes monitoring for paging for a group notification message for activation of the multicast session associated with the MBS session ID or the TMGI through at least one of unicast Paging Occasions (POs), group paging with common POs, and a MCCH change notification in response to determining that the UE has joined the at least one multicast session which is non-activated. In another embodiment, the method includes skipping monitoring for paging for a group notification message for activation of the multicast session associated with the MBS session ID or the TMGI on at least one of unicast POs, group paging with common POs, and a MCCH change notification in response to determining that the UE has not joined the at least one multicast session which is non-activated.

The proposed method provides solutions to which provide an efficient and effective approach for multicast session notification signalling and procedure for the NR multicast broadcast services (MBS).

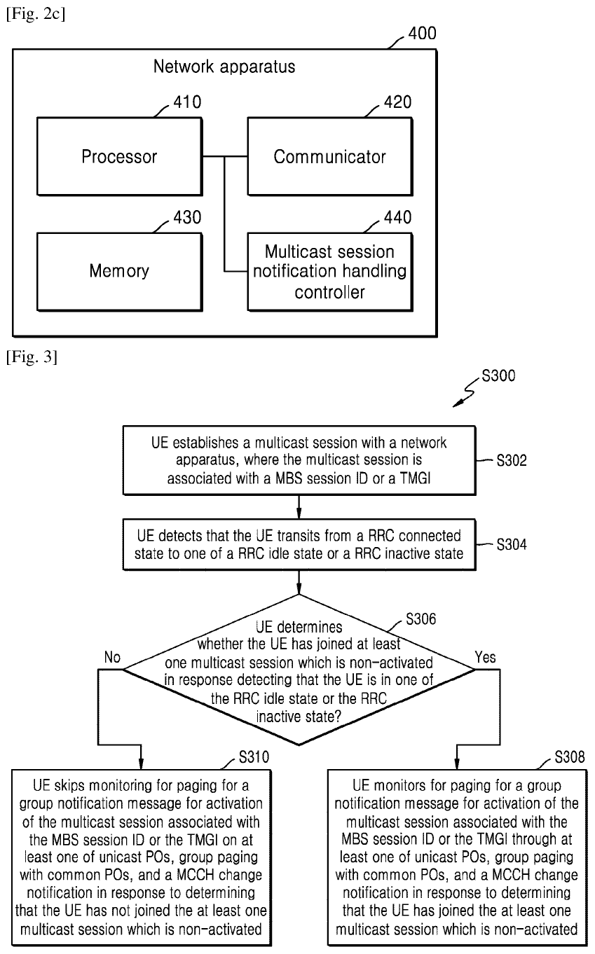

Referring now to the drawings and more particularly to FIGS. 2a through 17, where similar reference characters denote corresponding features consistently throughout the figures, there are shown preferred embodiments.

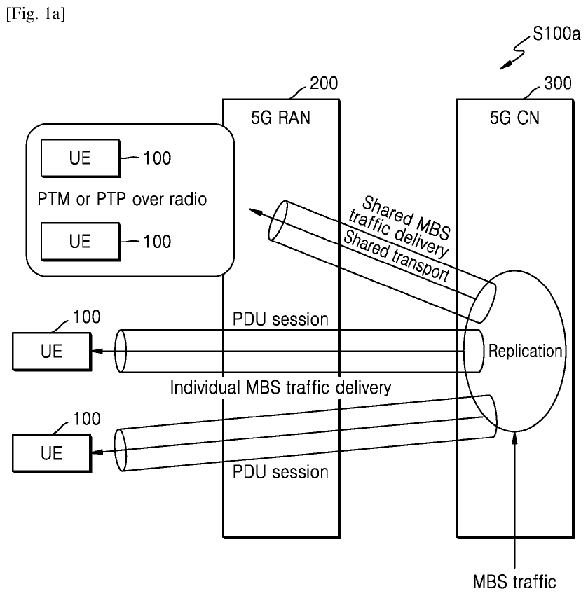

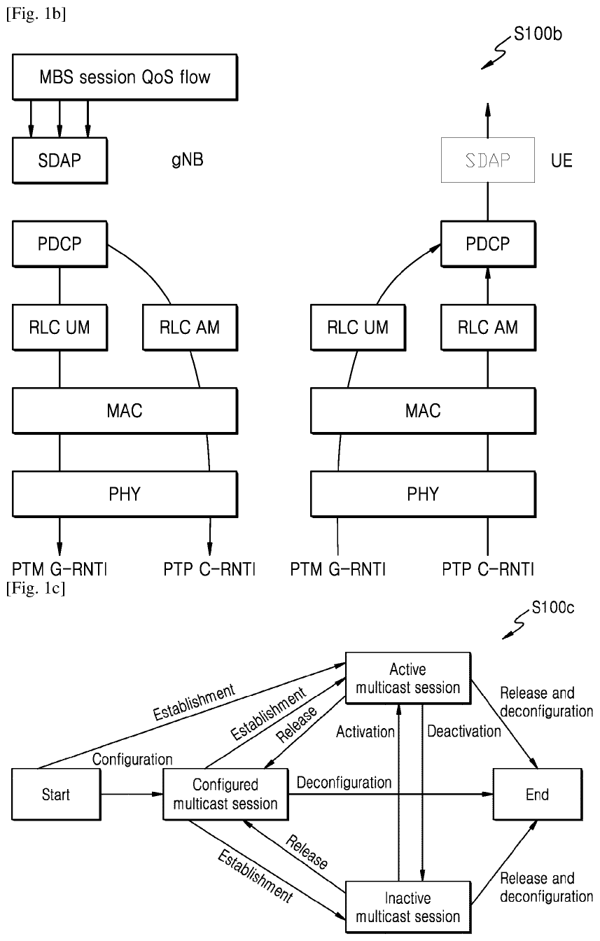

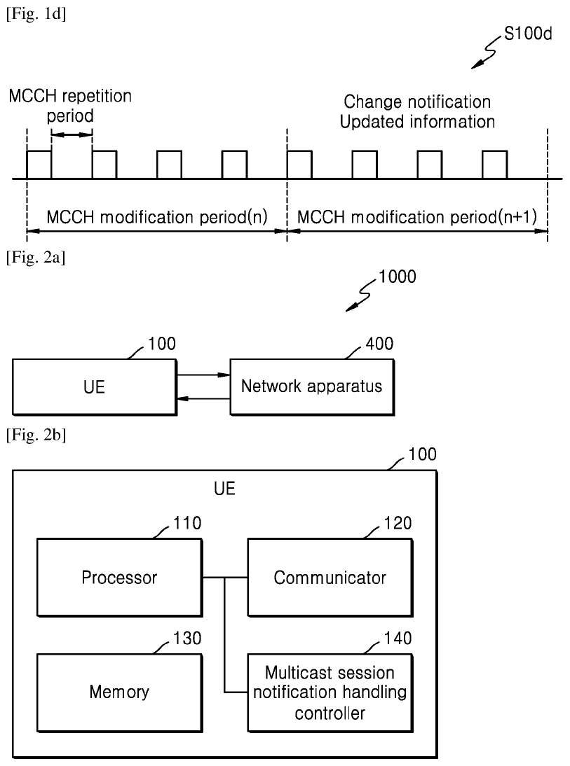

FIG. 1a illustrates (100a) MBS delivery from a Core Network (CN) (300) to a 5G RAN (200) and a UE (100). Referring to the FIG. 1a, the 5G Core Network (CN) (300) can deliver MBS user data to the Radio Access Network (RAN) (200) using following delivery methods.

Individual delivery: for each individual UE receiving the MBS service, the 5G CN (300) delivers separate copies of the MBS user data packets to the RAN (200) (i.e., via per-UE PDU sessions, alike in case of unicast delivery).

Shared delivery: The 5G CN (300) delivers a single copy of MBS user data to the 5G RAN (200) i.e., via a shared PDU session/tunnel), with RAN handling delivery to one or multiple UEs.

In case of shared delivery by the 5G CN (300), the RAN (200) delivers MBS data to the UEs (100) using either Point-to-Point delivery (PTP) or Point-to-Multipoint (PTM) delivery. Furthermore, at the UE (100), reception via an MBS radio bearer (MRB) can be supported using:
a. A single/common Service Data Adaptation Protocol (SDAP) entity,
b. A single/common Packet Data Convergence Protocol (PDCP) entity, and
c. A single PTM RLC bearer, a single PTP RLC bearer or a combination i.e., the UE simultaneously configured with a PTM and a PTP RLC bearer (also referred to as PTM and PTP legs).

More specifically, the UE (100) can be configured with:
a) A PTM RLC bearer only,
b) A PTP RLC bearer only, either using RLC Unacknowledged Mode (UM) or RLC Acknowledged Mode (AM),
c) A split RLC bearer i.e., both a PTM and PTP RLC bearer, both using RLC UM,
d) A split RLC bearer i.e., both a PTM and PTP RLC bearer, using RLC UM and RLC AM respectively, and
e) A split RLC bearer i.e., both a PTM and PTP RLC bearer, both using RLC AM.

FIG. 1b illustrating an example of protocol stack (100b) for MBS in NR. Referring to the FIG. 1b, for broadcast services, MCCH (MBS Control Channel) and MTCH (MBS Traffic Channel) are supported for control signalling and traffic respectively. The MCCH configuration is provided by BCCH (i.e. a system information block). In turn, the MCCH carries configuration information for the MTCH channels and services related information. Broadcast MBS services can be supported in Idle or Inactive or Connected mode in identical manner. This also implies only PTM mode is feasible for broadcast services.

FIG. 1c illustrating an example of multicast session state and state transition (100c). As depicted, the multicast session state can transition among configured, active, inactive and de-configured state.

FIG. 1d illustrating an example of MCCH transmission (100d), according to the embodiments as disclosed herein. As depicted, MCCH change notification (when there is a change in MCCH contents) and updated information are provided in the same modification period for the MCCH.

FIG. 2a illustrates overview of a wireless network (1000) for a multicast session notification signalling and procedure, according to the embodiments as disclosed herein. In an embodiment, the wireless network (1000) includes the UE (100) and a network apparatus (400). The UE (100) can be, for example, but not limited to a laptop, a desktop computer, a notebook, a relay device, a Device-to-Device (D2D) device, a vehicle to everything (V2X) device, a smartphone, a tablet, an immersive device, a television, and an internet of things (IoT) device. The wireless network (1000) can be, for example, but not limited to a 4G network, a 5G network, a 6G network, ORAN network or the like.

In the wireless network (1000), as shown in the FIG. 1c, the MBS/multicast services/sessions can be in different services states e.g. configured, started, activated, deactivated, stopped, released, deconfigured. Therefore, there is a need to notify the UE (100) or UE-group about the service state or change of service state as UEs (100) may be in different RRC states (e.g. RRC_IDLE, RRC_INACTIVE, RRC_CONNECTED) and is not aware about this. Furthermore, different approaches for this MBS/multicast session notification signalling may be needed given the different RRC states for UE and/or different signalling support by RAN (Radio Access Nodes) and/or efficiency/flexibility of the signalling approach and so on. Different approaches may have different advantages and/or deficiencies.

In an embodiment, the MBS/multicast notification is conveyed by the network apparatus (400) to the UE (100). Further, it is utilized for at least one of the following possible combination, for one or more MBS/multicast session or one or more group of MBS/multicast sessions:
a) MBS/Multicast session activation,
b) MBS/Multicast session deactivation,
c) MBS/Multicast session stop,
d) MBS/Multicast session release,
e) MBS/Multicast session start.

The activation also implies resumption, and deactivation also implies suspension for the MBS/multicast session. In general, MBS/multicast notification is broadly categorized as following:
a. Unicast paging (or Group paging with unicast POs): each UE (100) monitors a different, UE specific, paging occasion and if indication is detected, the UE (100) receives message. May be applicable in RRC_IDLE and RRC_INACTIVE. Though, the unicast paging occasions are used to convey the activation notification for the multicast sessions with pertaining TMGI(s), the approach is also called “group notification or group paging or paging with unicast POs” in the patent disclosure.
b. Group paging with common POs: all UEs (100) monitor the same common paging occasions and if indication is detected, UE (100) receives message. May be applicable in RRC_IDLE and RRC_INACTIVE.
c. Common signalling: UE (100) periodically acquires the common/broadcast signalling like SIB or MCCH including MCCH change notification. May be applicable in RRC_IDLE and RRC_INACTIVE.
d. Dedicated signalling like RRC, MAC or L1 signalling based. May be applicable in RRC_CONNECTED. In an example, in RRC_CONNECTED state, RRC reconfiguration message carrying the MBS Radio Bearer (MRB) setup implies activation of the multicast session. The RRC reconfiguration message carrying the MBS Radio Bearer (MRB) release pertaining to the deactivated multicast session. MRB release is therefore an implicit way for the deactivation signalling.

In an embodiment, the MBS/multicast notification is conveyed and utilized through at least one of the following possible combination, for one or more MBS/multicast session or one or more group of MBS/multicast sessions:
a. Unicast paging based approach where in at least one paging identity is utilized for at least one MBS/multicast session. Paging identity can be set to MBS session Id or TMGI. This can be in addition to the paging identity used for unicast paging for the UE (100). Paging channel can be addressed to P-RNTI.
b. Unicast paging based approach where in at least one paging cause is utilized for at least one MBS/multicast session. Paging cause can be set to MBS session Id or TMGI. Paging channel can be addressed to P-RNTI.
c. Group paging/notification with unicast POs based approach wherein same PO/PF is used as unicast paging and at least one of paging identity and/or paging cause for at least one of MBS/multicast session notification. Group paging can be addressed to P-RNTI. The paging identity can be set to MBS session Id or TMGI. This can be in addition to the paging identity used for unicast paging for the UE.
d. Group paging with common POs based approach wherein different PO/PF is used as that for unicast paging and at least one of paging identity and/or paging cause for at least one of MBS/multicast session notification. Group paging can be addressed to a common MBS RNTI or M-RNTI or service specific G-RNTI.
e. MCCH change notification and MCCH based approach wherein at least one PDCCH/DCI bit in MCCH change notification is used to notify for at least one MBS/multicast session notification or at least one group of MBS/multicast sessions. Further, MCCH conveys at least one MBS/multicast session Id and/or at least one MBS/multicast session group ID. This can be at least one of activated and/or deactivated and/or started and/or stopped/released MBS/multicast session or a group of MBS/multicast sessions.
f. RRC reconfiguration message including at least one of activation, deactivation, start, stop, configuration and release for one or more MBS/multicast session.
g. MAC signalling (e.g. MAC Control Element) including at least one of activation, deactivation, start, stop and release for one or more MBS/multicast session.
h. L1 signalling (e.g. PDCCH) including at least one of activation, deactivation, start, stop and release for one or more MBS/multicast session.
i. RRC release message (e.g. including deactivation for one or more MBS/multicast session along with transition to idle state).
j. RRC release with suspend configuration (e.g. including deactivation for one or more MBS/multicast session along with transition to Inactive state).

In an embodiment, the MBS/multicast notification message is consisting of at least one or more instances of at least one of the fields and possible combination of the fields as following:
a) Indication that notification is for MBS purpose,
b) MBS Session Id or TMGI,
c) Paging Identity,
d) Paging cause,
e) New state for one or more MBS/Multicast session or session group (e.g., activated, deactivated, start, stop, suspend, released etc.),
f) New RRC state to receive for activated and/or started MBS session (e.g., RRC_IDLE, RRC_INACTIVE, RRC_CONNECTED) and/or RRC state(s) where MBS session is receivable,
g) Access attempt delay or back-off information (e.g., need for access attempt delay, delay value/approach for access attempt),
h) Distribution or randomization approach for access attempt
i) Congestion status for transitioning to RRC_CONNECTED state,
j) Access class, access category, access identity for at least one MBS session or group of sessions,
k) MBS/multicast session or session group (e.g., deactivated session, activated session etc.),
l) List of MBS/multicast session or session group (e.g. list for activated MBS/multicast sessions, list for deactivated MBS/multicast sessions and so on),
m) Applicable bearer mode (e.g. PTM, PTP or PTM+PTP) for activated and/or started MBS session
n) PTM configurations to apply for activated and/or started MBS session,
o) PTP configurations to apply for activated and/or started MBS session,
p) Indication for PTM and/or PTP and/or PTM+PTP delivery mode applicable,
q) PDCP and/or RLC PDU initial sequence number (e.g., first sequence number after activation like “0” or some SN “x” or set to/as per SN of first PDU received or resumption of SN from deactivation state)
r) PDCP and/or RLC entities' initial values of state variables,
s) Security context/keys to apply for activated and/or start MBS session, and
t) BWP configurations to apply for activated and/or started MBS session.

In an embodiment, the MBS/multicast notification is received by the UE (100) in at least one of the following RRC states:
a. RRC_IDLE state,
b. RRC_INACTIVE state, and
c. RRC_CONNECTED state.

In an embodiment, in the RRC_CONNECTED state, in order to avail the MBS/multicast notification (e.g., activation, deactivation, start, stop, release etc.), at least one of the following is adopted:
a) It is specified which approach among dedicated signalling or group notification shall be utilized,
b) The network apparatus (400) configures the UE (100) for the approach among dedicated signalling or group notification,
c) The UE (100) chooses between dedicated signalling (e.g. NAS signalling, RRC signalling, MAC signalling) and MBS/multicast group notification (e.g. group paging, MCCH change notification and MCCH). The UE (100) may also inform the network apparatus (400) for the approach chosen so that the network apparatus (400) operates and provides signalling/notification appropriately,
d) Only dedicated signalling based approach is used,
e) Only unicast paging (i.e. group paging/notification with unicast POs) approach based approach is used,
f) Only group paging with common POs based approach is used, and
g) Only MCCH change notification and MCCH based approach is used.

In an embodiment, the network apparatus (400) configures the UE (100) in the RRC_CONNECTED mode to receive MBS/multicast session notification (e.g., through group paging with unicast POs, group paging with common POs or MCCH based approach), based on the initial BWP and/or MCCH/SI/paging search spaces configuration overlapping/availability within the unicast active BWP. Otherwise, the network apparatus (400) provides dedicated signalling to the UE (100) for the MBS/multicast session notification.

### Activation and Deactivation:

In an embodiment, consider an activation/deactivation process, upon the MBS/multicast notification reception,
a. When it includes activation of one or more MBS/multicast session, the UE (100) transits to and/or receives MBS/multicast session in at least one of the following RRC states; or
b. When it includes deactivation of one or more or all active MBS/multicast session(s) for the UE (100), the UE (100) transits to at least one of the following RRC states;
a. RRC_IDLE state,
b. RRC_INACTIVE state,
c. RRC_CONNECTED state,
d. Same RRC state wherein the UE (100) received the MBS/multicast notification message, and
e. In the RRC state which is indicated in the MBS/multicast notification message.
c. When it includes deactivation of all active MBS/multicast session for the UE (100), the UE (100) transits to at least one of the following RRC states and there is unicast DRB actively being transmitted/received and/or after a specified or configured time duration (e.g. an inactivity timer Txxx expiry); or
a. RRC_IDLE state, and
b. RRC_INACTIVE state.

In an embodiment, the UE (100) preserves/stores the configuration and/or security context/keys for PTM and PTP for the MBS/multicast session, when the session is deactivated and the UE (100) continues in the RRC_CONNECTED and/or the UE (100) transitions to RRC_IDLE and/or RRC_INACTIVE state. Further, when the UE (100) receives MBS/multicast session notification for activation, the UE (100) restores the configuration and/or security context/keys for PTM and/or PTP for the MBS/multicast session and quickly recovers the session. The PTM and/or PTP configuration may include configuration for SDAP/PDCP/RLC/MAC/HARQ entities and parameters.

In case of change or modification of the configuration for MBS/multicast session, network can indicate the “update” indication to the UE (100) (e.g., in the MBS/multicast session information in the paging/MCCH), accordingly the UE (100) configures/reconfigures/modifies the PTM and/or PTP for MBS/multicast session as per dedicated signalling. Alternatively, the UE (100) receives MBS/multicast session notification and/or updated configurations directly from the dedicated signalling e.g., in the RRC reconfiguration message when the UE (100) is in RRC_CONNECTED state. In an embodiment, in the RRC reconfiguration message, a MBS session setup implies session activation and a MBS session release implies session deactivation.

In an embodiment, the network apparatus (400) may employ different configurations for receiving MBS/multicast sessions for different states (e.g., Same Multicast session reception in the RRC_INACTIVE state and in RRC_CONNECTED state may have different configuration). It may also be possible that same MBS/multicast session configuration may be applicable for multiple RRC states.
a. The UE (100) stores the configuration with info about the applicable RRC state X (and possibly multiple configurations i.e. one for each RRC state used).
b. When the UE (100) receives notification indicating service is (re-) activated in RRC state X and the UE (100) has configuration stored for that, it will resume using that RRC state or consider that as baseline for delta signalling across different RRC states (i.e. MBS/multicast session configuration has common configuration part and differential configuration part across RRC states).

In an embodiment, the UE (100) preserves/stores the security context/keys either partially or fully pertaining to the MBS/multicast session when it is being deactivated for application when the session is activated again, at least considering one the factors or a possible combination of the following:
a. The UE (100) preserves the security context/keys when the UE (100) remains in RRC_CONNECTED state between deactivation and activation. That is, if UE leaves RRC_CONNECTED state, the UE releases the security context/keys,
b. The UE (100) preserves the security context/keys irrespective of the RRC state of the UE (100) between deactivation and activation,
c. The UE (100) preserves the security context/keys when the UE (100) transits to RRC_INACTIVE state between deactivation and activation,
d. The UE (100) preserves the security context/keys when the UE (100) transits to RRC_IDLE state between deactivation and activation, and
e. The UE (100) does not preserve the security context/keys in any RRC state between deactivation and activation. That is, the UE (100) releases security context/keys either partially or fully when the multicast session is deactivated.

In an embodiment, upon the MBS/multicast notification reception (e.g. received through dedicated signalling or group notification), when it includes activation of one or more MBS/multicast session, the UE (100) undertakes at least one of the operations.
a. Transit to RRC_IDLE or RRC_INACTIVE state, if the multicast session is provided in RRC_IDLE or RRC_INACTIVE,
b. Transit to RRC_CONNECTED state, if the multicast session is provided in RRC_CONNECTED,
c. If in RRC_CONNECTED, stop monitoring for group notification for MBS/multicast session,
d. PDCP entity establishment/reestablishment pertaining to MBS/multicast session,
e. Establish or reconfigure PTM and/or/PTP RLC bearer and entity/entities pertaining to MBS/multicast session,
f. Establish or reconfigure MTCH and/or DTCH Logical channel(s) pertaining to MBS/multicast session,
g. Restores the configuration and/or security context/keys for PTM and/or PTP bearer pertaining to deactivated MBS/multicast session, and
h. Initialize HARQ buffer(s)/process/processes pertaining to MBS/multicast session,

When it includes deactivation of one or more MBS/multicast session, the UE (100) undertakes at least one of the following operations:

### Approach A:

a. PDCP entity reestablishment pertaining to MBS/multicast session,
b. PTM and/or/PTP RLC bearer or entity/entities release pertaining to MBS/multicast session,
c. MTCH and/or DTCH Logical channel(s) release pertaining to MBS/multicast session,
d. Stores/preserves the configuration and/or security context/keys for PTM and/or PTP bearer pertaining to deactivated MBS/multicast session,
e. Clear HARQ buffer(s)/process/processes pertaining to MBS/multicast session,
f. MAC reset, if this is last MBS/multicast session and no other PTM/PTP/unicast service is active,
g. Transit to RRC_IDLE or RRC_INACTIVE state, if there is no PTM/PTP/unicast bearer is active and/or an in activity or Data-Inactivity timer has expired; otherwise continues in RRC_CONNECTED state, and
h. If RRC_IDLE and/or RRC_INACTIVE, start monitoring for group notification for this MBS/multicast session ID,

### Approach B:

a. PDCP entity reestablishment pertaining to MBS/multicast session,
b. Suspend PTM and/or/PTP RLC bearer pertaining to MBS/multicast session,
c. Suspend MTCH and/or DTCH Logical channel(s) pertaining to MBS/multicast session,
d. Clear HARQ buffer(s)/process/processes pertaining to MBS/multicast session,
e. MAC reset, if this is last MBS/multicast session and no other PTM/PTP/unicast service is active,
f. Transit to RRC_IDLE or RRC_INACTIVE state, if there is no PTM/PTP/unicast bearer is active and/or an inactivity or Data-Inactivity timer has expired; otherwise continues in RRC_CONNECTED state, and
g. If RRC_IDLE and/or RRC_INACTIVE, start monitoring for group notification for this MBS/multicast session ID.

### Approach C:

a. PDCP entity release pertaining to MBS/multicast session,
b. PTM and/or/PTP RLC bearer release pertaining to MBS/multicast session,
c. MTCH and/or DTCH Logical channel(s) release pertaining to MBS/multicast session,
d. Release/clear the configuration and/or security context/keys for PTM and/or PTP bearer pertaining to deactivated MBS/multicast session,
e. Clear HARQ buffer(s)/process/processes pertaining to MBS/multicast session,
f. MAC reset, if this is last MBS/multicast session and no other PTM/PTP/unicast service is active,
g. Transit to RRC_IDLE or RRC_INACTIVE state, if there is no PTM/PTP/unicast bearer is active and/or an in activity or Data-Inactivity timer has expired; otherwise continues in RRC_CONNECTED state, and
h. If RRC_IDLE and/or RRC_INACTIVE, start monitoring for group notification for this MBS/multicast session ID.

### UE Initiated Notification Request:

Consider the UE (100) initiated notification request, the UE (100) initiated notification request is triggered by the UE (100) which is for start and activation for at least one MBS/multicast session and session-group,
a. When the UE (100) missed the MBS/multicast notification in RRC_IDLE or RRC_INACTIVE or RRC_CONNECTED state,
b. When the UE's BWP is switched and new BWP supports or provides the required MBS/multicast session,
c. When the UE (100) has a new interest in MBS/multicast session,
d. When the UE (100) can now support the MBS/multicast session along with the unicast service/session and/or UE preference is changed to MBS/multicast as against unicast,
e. When the UE (100) enters in or out a cell/area which supports the MBS/multicast session,
f. When the UE (100) moves in or out a legacy and/or non-MBS supporting RAN node and requires an MBS session notification from the network apparatus (400), and
g. When the UE (100) has certain capability limitation or changes (e.g. capability changes, BWP, priority, temporary interest change) and need to request to network whether notification is provided or not provided to UE.

In an embodiment, the UE initiated notification request is triggered by the UE (100) which is for deactivation and/or stop and/or release for at least one MBS/multicast session and/or session-group,
a. When a configured timer Txxx expires and/or timer Txxx is about to expire (e.g., Data-Inactivity Timer or MBS Data Inactivity timer expires as no multicast packet is received for the timer duration),
b. When UE's BWP is switched and new BWP does not support or provide the required MBS/multicast session,
c. When the UE (100) loses interest in the MBS/multicast session,
d. When the UE (100) cannot support the MBS/multicast session along with the unicast service/session and/or UE preference is changed to unicast as against MBS/multicast,
e. When the UE (100) moves in or out a cell/area which does not support the MBS/multicast session,
f. When UE (100) moves in or out a legacy and/or non-MBS supporting RAN node and requires an MBS session notification from the network apparatus (400), and
g. When UE has certain capability limitation or changes (e.g., capability changes, BWP, priority, temporary interest change) and need to request to network whether notification is provided or not provided to UE.

In an embodiment, the UE (100) initiated MBS/multicast notification request is provided to the network apparatus (400) to start receiving notification from the network and/or to stop receiving notification from the network.

In an embodiment, the UE initiated MBS/multicast notification request is provided to the network apparatus (400) by utilizing at least one of RRC signalling (e.g. UE assistance information, MBS interest indication, RRC connection request, RRC Resume request, UE capability information message, new RRC message as MBS notification request message, other RRC message), MAC signalling (MAC CE) and NAS signalling.

The UE initiated MBS/multicast notification request includes at least one of MBS session identity or TMGI, type(s) of notification needed (e.g. activation, deactivation, start, stop, release etc.), notification mode (e.g. dedicated signalling, unicast paging, group paging, MCCH based), preferred BWP to receive multicast session, preferred RRC state (e.g. RRC_CONNECTED, RRC_IDLE, RRC_INACTIVE) to receive multicast session, preferred mode (e.g. PTM, PTP or PTM+PTP) to receive multicast session).

In an embodiment, a notification prohibit timer Txxx is configured by network and is used to control frequent sending of the MBS/multicast notification request by the UE. That is, a new triggered notification request is sent only when timer Txxx is not running and/or is deferred until timer Txxx is expired. Timer Txxx is started/restarted after sending of notification request. Only one notification request is sent, even when there are more than one triggers happened for notification request before sending of the present notification request.

Notification Request Message

{
- MBS session Id or TMGI (or a list)
- Notification Type
- Notification Mode
- Preferred BWP
- Preferred RRC state
- Preferred mode
}

### UE Capability and Network Configuration:

Consider the UE capability and network configuration, the UE (100) conveys the UE capability related information for the MBS/multicast session support to the network apparatus (400). This information is conveyed by utilizing at least one of the message including but not limited to the UE capability information message, the UE assistance information message, RRC Connection request, RRC Resume request, RRC setup complete message, MBS interest indication message etc. The message can include at least one of the following information in the form of bit(s)/bit-map or field(s):
a. Support for MBS/multicast in RRC state or multiple RRC states (e.g., RRC_IDLE, RRC_INACTIVE, RRC_CONNECTED, None),
b. Support for MBS/multicast notification approach or approaches (e.g., unicast paging, group paging, MCCH based, None),
c. Support for one or multiple BWPs simultaneously or not,
d. Support for parallel reception for unicast and MBS and related approach e.g., TDM, FDM, Carrier aggregation, dual connectivity, and
e. Support for simultaneous reception of one or more G-RNTIs/G-CS-RNTIs together.

Network may configure UEs in accordance with the reported UE capability information and utilizing one of the notification and/or signalling approaches as described earlier.

Unicast Paging (i.e. Group Notification/Paging with Unicast POs):

Consider the unicast paging, in an embodiment, same PF and PO for unicast paging are utilized to also convey MBS/multicast session notification. To cater to all the UEs, notification has to be repeated on all the PF and PO of the unicast paging cycle of the UEs. The advantage, this approach brings, is the increased power saving as UE needs to be awake only during its own legacy unicast paging PF/PO only and can also receive MBS/multicast notification.

In an embodiment, the UE receives the MBS/multicast session notification over unicast paging occasion (PO) and paging frame (PF) as determined by

$$PF : ( SFN + PF\_offset ) mod T = ( T div N ) * ( UE\_ID mod N )$$

$$PO index = floor ( UE\_ID / N ) mod Ns$$

Where,
T: DRX cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied).
N: number of total paging frames in T
Ns: number of paging occasions for a PF
PF_offset: offset used for PF determination
UE_ID: 5G-S-TMSI mod 1024

As PF/PO computation for MBS/multicast notification matches with the legacy unicast paging, each UE needs to receive MBS/multicast service without any additional or different awake occasions.

In an embodiment, UEs belonging to different POs of the same PF receive paging at different occasions (i.e. PO), and MBS/multicast notification may be transmitted in each of these POs of the PF, provided respective UE(s) have joined the MBS/multicast session and are needed to be notified for MBS notification. This approach however may affect the paging capacity for the network as MBS/multicast notification may be repeated in many POs of the same PF.

In an embodiment, a separate one (or more) PO(s) of the PF may be configured wherein, MBS/multicast notification is provided and all the UEs which are receiving legacy unicast paging in one of the PO of the PF, can monitor for MBS/multicast notification in the separately configured PO(s) of the PF and uses a MBS_Sess_ID to monitor for MBS notification. This way, it is not required to repeat the MBS/multicast notification in each of the POs of the PF, for the respective UE(s) that have joined the MBS/multicast session and are needed to be notified for MBS session notification. That is, MBS notification is required to be provided once in the PF.

$$PF : ( SFN + PF\_offset ) mod T = ( T div N ) * ( UE\_ID mod N )$$

$$MBS\_PO index = floor ( MBS\_Sess \_ID / N ) mod Ns$$

In an embodiment, MBS_PO_index (specifies the PO used for MBS/multicast session notification) and/or MBS_Sess_ID is/are configured to the UE. Configuration can be provided in dedicated signalling (e.g. RRC reconfiguration, RRC Release, RRC Release with suspend config, Deactivation message etc.) or broadcast signalling (e.g. SIB, MBS SIB, MCCH etc.).

In an embodiment, MBS_PO_index can be fixed, specified or configured as one index (e.g. 0<=MBS_PO_index<Ns). That is, it is independent of the MBS_Sess_ID.

In an embodiment, MBS_Sess_Id is set to a common value for all MBS/multicast sessions. That is, effectively notifications for all MBS/multicast sessions occur at same time (PO) for all the UEs and they can receive at same time.

In an embodiment, in order to notify for MBS/multicast notification, at least one of the following approaches or a possible combination of the following approaches are adopted as—
A. Group notification/paging with unicast POs based approach where in at least one paging identity (i.e. PagingUE-Identity) is utilized for at least one MBS/multicast session. PagingUE-Identity can be set to MBS session Id or TMGI. This can be in addition to the paging identity used for unicast paging for the UE i.e. this is an alternate PagingUE-Identity for MBS. (see Table A)
B. Unicast paging based approach where in at least one PagingCause in a paging record or in a paging message is utilized for at least one MBS/multicast session. PagingCause can be set to MBS or MBS session Id or TMGI. (see Table B)
C. Unicast paging based approach where in accessType field in at least one paging record or in a paging message is utilized to convey MBS purpose or convey for at least one MBS/multicast session. accessType can be set to MBS or MBS session Id or TMGI. (see Table C)
D. Group notification/paging with unicast POs based approach where in at least one new field or index or bitmap in a paging record or in a paging message is utilized for at least one MBS/multicast session. Each bit of bitmap or index or field can be set to one MBS session Id or TMGI and activation status can be notified e.g. first bit indicating first multicast session and set to 1 means activated session and so on (See Table D1 and D2).

Further, procedure and the message structure for Group notification/paging with unicast POs carrying a list of MBS session ID or TMGI is shown as below:
1> for each TMGI included in pagingGroupList, if any, included in the Paging message:
2> if the UE has joined an MBS session indicated by the TMGI included in the pagingGroupList:
3> forward the TMGI to the upper layers;
1> if in RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers:

2> initiate the RRC connection resumption procedure according to 5.3.13 with resumeCause set to mt-Access.

```
  Paging-v17xy-IEs ::= SEQUENCE {
  pagingGroupList-r17 PagingGroupList-r17 OPTIONAL,
  nonCriticalExtension SEQUENCE { } OPTIONAL
  }
  PagingGroupList-r17 ::= SEQUENCE
  (SIZE(1..maxNrofPageGroup-r17)) OF
TMGI-r17
```

In these approaches, paging channel can be addressed to P-RNTI. Paging occasion and paging frame is determined based on UE Identity, even if paging identity is set to MBS session Id.

TABLE A

| Paging ::= | SEQUENCE { |
|---|---|
| pagingRecordList | PagingRecordList |
| OPTIONAL, -- Need N | |
| lateNonCriticalExtension | |
| OCTETSTRINGOPTIONAL, | |
| nonCriticalExtension | SEQUENCE{ } |
| OPTIONAL | |
| } | |
| PagingRecordList ::= | SEQUENCE |
| (SIZE(1..maxNrofPageRec)) OF PagingRecord | |
| PagingRecord ::= | SEQUENCE { |
| ue-Identity | PagingUE-Identity, |
| accessType | ENUMERATED |
| {non3GPP} OPTIONAL, -- Need N | |
| ... | |
| } | |
| PagingUE-Identity ::= | CHOICE { |
| ng-5G-S-TMSI | NG-5G-S-TMSI, |
| fullI-RNTI | I-RNTI-Value, |
| MBS_Sess_ID | MBS_Sess_ID, |

...
}

TABLE B

| ... | |
|---|---|
| PagingRecord ::= | SEQUENCE { |
| ue-Identity | PagingUE-Identity, |
| accessType | ENUMERATED |
| {non3GPP} | |
| PagingCause | ENUMERATED {MBS} |

OPTIONAL, -- Need N
...
}
....

TABLE C

| ... | |
|---|---|
| PagingRecord ::= | SEQUENCE { |
| ue-Identity | PagingUE-Identity, |
| accessType | ENUMERATED |

{non3GPP, MBS}
OPTIONAL, -- Need N
...
}
....

TABLE D1

| ... | |
|---|---|
| PagingRecord ::= | SEQUENCE { |
| ue-Identity | PagingUE-Identity, |
| accessType | ENUMERATED |
| {non3GPP} | |
| bitmap | bitmap |

OPTIONAL, -- Need N
...
}
....

TABLE D2

| Paging ::= | SEQUENCE { |
|---|---|
| pagingRecordList | PagingRecordList |
| bitmap | bitmap |
| OPTIONAL, -- Need N | |
| lateNonCriticalExtension | |
| OCTETSTRINGOPTIONAL, | |
| nonCriticalExtension | SEQUENCE{ } |

OPTIONAL
}

Further, more than one MBS/multicast session notification can be added to the unicast paging. E.g. there are 32 possible paging records per PO and therefore, multiple of them can be used for different MBS/multicast sessions and identified by separate Paging UE-Identity or PagingCauseor accessTypefield set to pertinent MBS session ID or by bitmapset topertinent MBS session IDs.

In an embodiment, at least one PDCCH/DCI bit of paging and/or PEI (Paging Early Indication) and/or WUS (Wake-up signal) is used to notify if there is presence (or absence) of one or more or all MBS/multicast session notification in the paging message. If the presence is not indicated, UE may not need to receive paging PDSCH, at least for the MBS/multicast notification. Further, in an approach, separate PDCCH/DCI bits can indicate for different MBS/multicast sessions for which the mapping information is specified or pre-configured through dedicated signalling and/or broadcast signalling as described earlier.

In an embodiment, paging sub-grouping approach utilized for power saving for RRC_IDLE and/or RRC_INACTIVE UEs where unicast paging is indicated per sub-group through PDCCH/DCI approach is operated independent of the MBS/multicast session notification. There is no PDCCH/DCI bit of PEI used to notify multicast session notification. RRC_IDLE or RRC_INACTIVE UEs for which there is at least one multicast session deactivated, will ignore the PEI and will monitor for group notification/paging for multicast session activation.

In an embodiment, unicast paging is indicated per sub-group through PDCCH/DCI approach is operated also considering presence/absence of the MBS/multicast session notification.

In an embodiment, MBS/multicast notification is repeated in the unicast paging to provide reliability and robustness for UEs receiving. Repetition is performed every “N^{th}” paging DRX cycle where N>=1 for up to “M” repetitions where M>=1. Parameters M and N are specified and/or configured for the UE through dedicated signalling and/or broadcast signalling as described earlier.

Group Paging with Common POs:

Further, consider a group paging with common POs method, the group paging configuration is provided to the UE (100) by at least one of the following or a possible combination of the following:
a. SIB e.g., SIB1 or other SIB or a new SIB,
b. MBS SIB i.e., MBS specific SIB,
c. Dedicated signalling e.g., RRC reconfiguration,
d. NAS signalling,
e. Deactivation message e.g., RRC message indicating deactivation,
f. RRC release message,
g. RRC release with suspend configuration, and
h. MCCH.

In an embodiment, group paging configuration carries at least one of the following or a possible combination of following parameters:
a. MBS/multicast Paging cycle,
b. MBS session Id or TMGI,
c. Paging frame Offset,
d. Number of MBS/multicast paging frames in MBS/multicast Paging cycle,
e. Number of MBS/multicast Paging occasions in MBS/multicast paging frames,
f. Parameter N and M for group paging repetitions,
g. MBS BWP/CFR, and
h. Search space.

In an embodiment, the group paging is configured and/or provided over at least one of the following or a possible combination of the following—
a. BWP for MBS group paging,
b. One configured CFR among of MBS CFRs,
c. Respective MBS CFRs configured,
d. Each MBS CFR, and
e. Initial BWP.

Group Paging configuration

```
  {
  MBS/multicast Paging cycle - T_mbs
  MBS session Id or TMGI or G-RNTI - MBS_Sess_Id
  MBS Paging frame Offset - MBS_PF_offset
  Number of MBS/multicast paging frames in MBS/multicast Paging
  cycle-N_mbs
  Number of MBS/multicast Paging occasions in MBS/multicast
  paging frames-
Ns_mbs
  Parameter N and M for paging repetitions
  MBS BWP / CFR
  Search space
  First PDCCH monitoring occasion for PO
  Number of PDCCH monitoring occasions per SSB
  }
```

In an embodiment, the UE (100) determines the MBS/multicast group paging occasion (PO) and paging frame (PF) by:

$$PF : ( SFN + MBS\_PF \_offset ) mod T\_mbs = ( T\_mbs div N\_mbs ) * ( MBS\_Sess \_Id mod N\_mbs )$$

$$PO index = floor ( MBS\_Sess \_Id / N\_mbs ) mod Ns\_mbs$$

This implies UE interested in a specific MBS/multicast session needs to monitor respective PO/PF for specific MBS/multicast session group notification.

In an embodiment, the MBS/multicast Paging cycle −T_mbs can be independent of RRC state i.e. whether the UE is in RRC_IDLE, RRC_INACTIVE or RRC_CONNECTED, same configuration or value of T_mbs is used. This is unlike legacy unicast paging where T may change as per RRC state or configuration.

In an embodiment, MBS/multicast Paging cycle −T_mbs can be configured as per RRC state e.g. as per RAN paging cycle, if the UE is in RRC_INACTIVE or as per CN paging cycle if UE is in RRC_IDLE state.

In an embodiment, all the configuration parameters (except MBS_Sess_Id) are taken from configuration of unicast paging and utilized for MBS/multicast group paging.

In embodiment, instead of MBS_Sess_Id, a common value, say MBS_Common_Id, is used for multiple or all MBS/multicast sessions. That is, effectively notifications for multiple or all MBS/multicast sessions occur at same time (PF/PO) for all the UEs and they can receive at same time. That is, there can be possibly MBS_Common_Id1 for a group of MBS/multicast sessions, MBS_Common_Id2 for another group of MBS/multicast sessions and so on.

$$PF : ( SFN + MBS\_PF \_offset ) mod T\_mbs = ( T\_mbs div N\_mbs ) * ( MBS\_Common \_Id mod N\_mbs )$$

$$PO index = floor ( MBS\_Common \_Id / N\_mbs ) mod Ns\_mbs$$

In an embodiment, MBS/multicast notification is repeated in the group paging to provide reliability and robustness for UEs receiving. Repetition is performed every “Nth” group paging DRX cycle where N>=1 for up to “M” repetitions where M>=1. Parameters M and/or N are specified and/or configured for the UE through dedicated signalling and/or broadcast signalling as described earlier.

In an embodiment, group paging configuration and parameters (e.g. parameter T_mbs) can be configured per MBS/multicast session or per group of MBS/multicast sessions or commonly for all MBS/multicast sessions. With per session or per session-group fulfilling different latency requirements can be targeted whereas later can help to simplify and reduce burden/power consumption for the UE.

In an embodiment, with beamforming channel nature for PDCCH of the MBS/multicast, PDCCH monitoring occasions are repeated per beam (i.e. per SSB). However, the UE (100) can receive in accordance with the best beam/SSB it has determined.

In an embodiment, the UE (100) is specified or configured to use P-RNTI or M-RNTI and/or specific G-RNTI (pertaining to MBS_Sess_Id UE is interested) to descramble or receive MBS/multicast group paging PDCCH.

In an embodiment, at least one PDCCH/DCI bit of paging and/or PEI (Paging Early Indication) and/or WUS (Wake-up signal) is used to notify if there is presence (or absence) of one or more or all MBS/multicast session notification in the group paging message. If the presence is not indicated, UE may not need to receive group paging PDSCH for the MBS/multicast notification.

Further, in an approach, separate PDCCH/DCI bits can indicate for different MBS/multicast sessions for which the mapping information is specified or pre-configured through dedicated signalling and/or broadcast signalling as described earlier and/or through MBS_Common_ID and PO/PF mapping for MBS/multicast sessions.

Table GP1 shows one possible format for GroupPaging where PO/PF identify the MBS session Id. There can be other possible approaches to use a bitmap or index field for indicating notification for multiple MBS session Ids together and PO/PF can be commonly used for group paging. (See Table GP2, GP3, GP4 and GP5)

TABLE GP1

| | |
|---|---|
| GroupPaging ::= | SEQUENCE { |

NotiStatusENUMERATED{Activated}
}

TABLE GP2

| GroupPaging ::= | SEQUENCE { |
|---|---|
| GrouppagingRecordList | |
| GroupPagingRecordList | |
| } | |
| PagingRecordList ::= | SEQUENCE |
| (SIZE(1..maxNrofGroupPageRec)) OFGroupPagingRecord | |
| GroupPagingRecord ::= | SEQUENCE { |

MBS_Sess_IDMBS_Sess_ID,
...
}

Relevant MBS session ID can be TMGI. An example structure for the group paging message is as shown below:

```
  Paging-v17xy-IEs ::= SEQUENCE {
  pagingGroupList-r17 PagingGroupList-r17 OPTIONAL,
  nonCriticalExtension SEQUENCE { } OPTIONAL
  }
  PagingGroupList-r17 ::= SEQUENCE
  (SIZE(1..maxNrofPageGroup-r17)) OF
TMGI-r17
```

TABLE GP3

| GroupPaging ::= | SEQUENCE { |
|---|---|
| GrouppagingRecordList | |
| GroupPagingRecordList | |
| } | |
| PagingRecordList ::= | SEQUENCE |
| (SIZE(1..maxNrofGroupPageRec)) OF GroupPagingRecord | |
| GroupPagingRecord ::= | SEQUENCE { |

Bitmap bitmap,
...
}

TABLE GP4

| | |
|---|---|
| GroupPaging ::= | SEQUENCE { |
| Bitmap | bitmap, |

...
}

TABLE GP5

| GroupPaging ::= | SEQUENCE { |
|---|---|
| GrouppagingRecordList | GroupPagingRecordList |
| OPTIONAL, -- Need N | |
| } | |
| PagingRecordList ::= | SEQUENCE |
| (SIZE(1..maxNrofGroupPageRec)) OFGroupPagingRecord | |
| GroupPagingRecord ::= | SEQUENCE { |
| ue-Identity | GroupPagingUE-Identity, |
| ... | |
| } | |
| GroupPagingUE-Identity ::= | CHOICE { |
| MBS_Sess_ID | MBS_Sess_ID, |

...
}

### MCCH Based Notification:

Further, consider a MCCH based approach, the UE (100) monitors for MBS/multicast group notification in at least one of the following conditions:
a) The UE (100) is not receiving MCCH every modification period and has interest in at least one MBS/multicast session, UE monitors for MBS/multicast session notification through MCCH change notification and/or MCCH based approach. This may be applicable in RRC_IDLE and RRC_INACTIVE and/or RRC_CONNECTED states.
b) The UE (100) is not receiving MCCH every modification period and has interest in at least one MBS/multicast session deactivated, the UE monitors for MBS/multicast session notification (e.g. indicating activation, release etc.) through MCCH change notification and/or MCCH based approach. This may be applicable in RRC_IDLE and RRC_INACTIVE and/or RRC_CONNECTED states.
c) When the UE (100) is receiving MCCH every modification period and has interest in and/or has a deactivated at least one MBS/multicast session, UE receives the group notification by reading MCCH change notification and/or MCCH.
d) When the UE (100) has interest in at least one MBS/multicast session which is not provided by MRB or PTM mode (e.g. provided by other means like PTP or unicast DRB), UE receives the group notification by reading MCCH change notification and/or MCCH.
e) When the UE has interest in at least one MBS/multicast session which UE has not joined yet, UE receives the group notification by reading MCCH change notification and/or MCCH.

In an embodiment, the UE receives the MBS/multicast session notification (indicating e.g. configuration/activation/deactivation/start/stop/release etc.) for at least one MBS/multicast session or a group of session with at least one bit on PDCCH/DCI pertaining to the MCCH change notification. When first bit is set to 1 it indicates the presence of first MBS/multicast session or session-group notification and so on.

In an embodiment, MBS/multicast session change notification (e.g. start/activation of MBS/multicast session and/or change of MBS/multicast session information) is conveyed through a bitmap or a field or fields on the PDCCH/DCI of the MCCH change notification. When at least one of the PDCCH/DCI bit or bitmap or field is present/set and indicates related to MBS/multicast session, the UE acquires MCCH (i.e. MBS/multicast session information) e.g. in the earliest repetition in the modification period. Otherwise, the UE may not acquire MCCH.

In an embodiment, MBS/multicast session notification is conveyed through the PDCCH/DCI of the MCCH itself i.e. not the PDCCH/DCI of MCCH change notification. When at least one of the PDCCH/DCI bit or bitmap or field is present/set and indicates MBS/multicast session notification, the UE acquires MCCH (i.e. MBS/multicast session information) e.g. in the earliest repetition in the modification period.

In an embodiment, MBS/multicast session change notification (e.g. start/activation of MBS/multicast session and/or change of MBS/multicast session information) is conveyed through a bitmap or a field or fields on the PDCCH/DCI of the MCCH. When at least one of the PDCCH/DCI bit or bitmap or field is present/set and indicates related to MBS/multicast session, the UE acquires MCCH (i.e. MBS/multicast session information) e.g. in the earliest repetition in the modification period. Otherwise, the UE may not acquire MCCH.

In an embodiment, one or more bits on PDCCH/DCI (e.g. PDCCH/DCI of the MCCH change notification and/or PDCCH/DCI of MCCH) can be used to indicate notification for different MBS/multicast session(s) or session-group(s), e.g. When first bit is set to 1 it indicates the presence of first MBS/multicast session or session-group notification and so on.

In an embodiment, one or more bits on PDCCH/DCI (e.g. PDCCH/DCI of the MCCH change notification and/or PDCCH/DCI of MCCH) can be used to indicate whether notification pertains to configuration and/or activation and/or deactivation and/or start and/or stop and/or release of at least one MBS/multicast session or session-group.

In an embodiment, only UEs, which are interested in MBS/multicast session, monitor for MBS/multicast session notification through PDCCH/DCI of MCCH change notification and/or PDCCH/DCI of MCCH. Otherwise, UEs do not monitor for PDCCH/DCI of MCCH change notification and/or PDCCH/DCI of MCCH.

In an embodiment, UEs (100), which are actively receiving MBS/broadcast services and/or receiving MCCH every modification period, do not monitor for MBS/multicast session notification through PDCCH/DCI of MCCH change notification and/or PDCCH/DCI of MCCH.

In an embodiment, UEs (100), which are actively receiving MBS/broadcast services and/or receiving MCCH every modification period, do not monitor for MBS/multicast session change notification through PDCCH/DCI of MCCH change notification and/or PDCCH/DCI of MCCH.

In an embodiment, UEs (100), which are monitoring for MBS/multicast session notification through PDCCH/DCI of MCCH change notification and/or PDCCH/DCI of MCCH, need not receive MCCH every modification period, if there are no active broadcast services.

In an embodiment, there is cross-slot scheduling for MCCH PDSCH. That is, PDCCH/DCI for MCCH provides a K0 parameters which can have a value (K0>=0), where K0=0 implies same slot scheduling and K0>0 implies cross-slot scheduling. With cross-slot scheduling, UE achieves a power saving with possible sleep or power conservation between PDCCH and PDSCH. In another embodiment, there can be offset between PDCCH/DCI for MCCH change notification and MCCH PDSCH to prevent decoding and processing of MCCH PDSCH when there is no MCCH change notification for session start/session stop/MCCH modification is received.

In an embodiment, the MCCH carries at least one of the following or a possible combination of the following MBS/multicast session information—
a) At least one “newly” activated multicast session or a list of “newly” activated multicast session. The newly activated multicast sessions pertain to the multicast session(s) which are only recently activated as indicated with the setting of the at least one DCI bit in the MCCH change notification
b) “All” activated multicast session or a list of “all” activated multicast session. These multicast sessions pertain to the multicast sessions which are in activated state as of present.

In an embodiment, the MCCH may carry one or more lists for at least one of configured, activated, deactivated, started, stopped, released MBS/multicast sessions.

In an embodiment, the MCCH may carry at least one of the configuration for MBS/multicast session that includes but not limited to—
a. PTM configuration,
b. PTP configuration,
c. Indication for usage of PTP,
d. Threshold information (e.g. signal strength) for UE to go to Connected mode to avail PTP,
e. Congestion status (e.g. to go to connected mode),
f. Indication if service is only provided by unicast,
g. BWP configuration,
h. Applicable RRC state(s) to receive MBS/multicast session,
i. Access category and/or access identity,
j. Overload and/or back-off indicator,
k. Randomization approach and/or back-off value and/or access delay value,
l. ARFCN,
m. MBS session ID or TMGI,
n. HARQ configuration,
o. HARQ feedback support, and
p. HARQ retransmission on PTM or PTP

In an embodiment, for MBS/multicast session information purpose, the MCCH configuration includes at least one of the following or a possible combination of the following provisions—
a) A separate MCCH carries for multicast session(s) information. Configuration for multicast session(s) information specific MCCH is provided to the UE in SIB or MBS SIB or RRC signalling and includes repetition period, modification period, offset, duration of MCCH, BWP, multicast service area scope and other parameters and configurations.
b) One or more Multicast session information is provided on at least one of the MCCH(s) as relevant for the latency requirements of the multicast session(s). That is, it is possible to map different multicast session information on to different MCCHs.
c) All multicast session information is provided on the MCCH with the smallest modification period among all the MCCH(s) for the cell/area. It there are more than one MCCHs with the smallest modification period then it is specified or configured which one or all of these MCCHs carry multicast session information.
d) All multicast session information is provided on one MCCH among all MCCHs on the cell/area and it is specified or configured which MCCH carries the multicast session information to the UE (100).
e) Multicast session information is provided on the MCCH among all MCCHs on the cell/area which is specified or configured for the specific multicast session to the UE (100).

In an embodiment, repetition and/or modification period configuration can be differently mapped to different MBS/multicast sessions on the same MCCH e.g. to satisfy different latency requirement for different MBS/multicast services/sessions.

In an embodiment, the UE (100) acquires directly the MCCH to check the MBS/multicast session information e.g. UE could not receive the notification through MCCH change notification in the previous modification period(s) due to temporarily loss of service or coverage. From the available MBS/multicast session information on the MCCH, the UE determines the session status (e.g. whether it is activated or deactivated).

In an embodiment, the UE (100) acquires MCCH to check the MBS/multicast session information in the earliest occurring repetition in the modification period. That is, it is the immediate next repetition of the current modification period. If last repetition in the current modification period has already elapsed, it implies the first repetition in the next modification period

In an embodiment, multicast service area can be same or different than broadcast service area. Network may configure the multicast service area per multicast session and/or per MCCH. This implies when multicast service area is different from broadcast service area, the UE acquires and applies the multicast session information differently than the broadcast service information even though they may be contained in the same MCCH message.

### Handling RACH Congestion:

Consider a handling RACH congestion, when receiving MBS/multicast session notification, there is possibility for a RACH congestion when a large number of UEs attempt to access the network i.e. move to RRC_CONNECTED state. This could be problematic. In order to address this issue, invention provides multiple solutions that alleviates or resolves the problem of RACH congestion. In the following description, approaches for RACH congestion handling are described generically for MBS/multicast session notification which can be based on unicast paging or group paging or MCCH change notification based or MCCH based notification.

In an embodiment, the MBS/multicast session notification message includes overload or back-off indicator field(s) that indicates for either selectively for one or more multicast session or collectively for all multicast sessions in the notification message. On receiving overload or back-off indicator, the UE(s) attempts to access the multicast session (e.g. attempt to establish connection with random access and receive multicast session) by deferring by certain time duration or back-off. The overload or back-off for the multicast session can be based on their priority and/or latency requirements.

In another approach, MBS/multicast session notification message may not include overload or back-off indicator for one or more MBS multicast session that implies UEs (100) can access these sessions without any deferment.

In an embodiment, UEs apply the randomization for the access attempt by different UEs i.e. uses different random values for the back-off and/or (re-)attempting the access. Distribution or Randomization approach (e.g. uniformly distributed etc.) or back-off value or range of values are specified or configured. In another approach, MBS/multicast session notification message may not include randomization approach or back-off value for one or more MBS multicast session that implies UEs can access these sessions without any random back-off.

In an embodiment, MBS/multicast session notification message includes access delay values per MBS/multicast session i.e. different access delay values for access attempt can be provided for different MBS/multicast sessions. Access delay values for the multicast session can be based on their priority and/or latency requirements. In another approach, MBS/multicast session notification message may not include delay value for one or more MBS multicast session that implies UEs can access these sessions without any delay.

In an embodiment, MBS/multicast session notification message can include the Access category and access identity/identities for MBS/multicast session(s). These parameters may be configured per MBS/multicast session and are utilized for connection establishment as part of Unified Access Control (UAC) mechanism. Scope of the UAC can be defined and/or configured for the cell/area/PLMN. Based on the UAC parameters configuration, the UE (100) attempts to establish RRC connection (e.g. RRC connection request and/or RRC Resume request). In another approach, MBS/multicast session notification message may not include Access category and access identity/identities for one or more MBS multicast session that implies UEs need not apply UAC mechanism for these MBS/multicast sessions.

In an embodiment, congestion status for the cell and/or for all MBS/multicast session and/or for each of the MBS/multicast session related access attempt is indicated or broadcasted (e.g. in SIB/MBS SIB/MCCH/paging) for the RRC_IDLE and/or RRC_INACTIVE UEs and accordingly, UE attempts to establish RRC connection when congestion status allows access attempt. Alternatively, UE determines to avail MBS/multicast session in RRC_IDLE and/or RRC_INACTIVE, if supported and when congestion is indicated.

In an embodiment congestion information collectively includes all the aforementioned parameters (e.g. overload indicator, back-off indicator, randomization or distribution approach, back-off value, delay value, congestion status, access category, access identity etc.) and is specified or configured as
a) Common for all MBS services
b) Separate per MBS service/session

In an embodiment, the UE includes at least one of the parameters in the Connection establishment message (e.g. Msg3, RRCConnectionRequest, RRCSetupRequest, RRCSetupComplete, RRCReestablishmentRequest, RRCReestablishmentComplete, RRCResumeRequest, RRCResume Request1, RRCResumeComplete etc.) but not limited to
a. Connection establishment cause or Reestablishment cause or Resume cause set as “MBS” or “multicast”,
b. MBS session ID or TMGI,
c. Required BWP,
d. Required ARFCN,
e. Required mode (e.g. PTM, PTP, PTM+PTP), and
f. Preferred RRC mode to receive MBS/multicast (e.g., RRC_CONNECTED, RRC_INACTIVE, and RRC_IDLE).

In an embodiment, a specified or configured set of preambles (Msg1 or Msg A) are used for random access for MBS/multicast session. The UE (100) may randomly select one of these preambles. Alternatively, UE (100) is assigned a specific preamble. Further, network notifies the UE (100) in the Random Access Response (RAR/Msg2 or MsgB) with the overload or back-off indication in case there is congestion.

In an embodiment, if the UE (100) also has, concurrently, unicast reason for connection request (e.g. service request or arrival of unicast uplink data) when it has to receive MBS/multicast notification (e.g. for activation) and needs to transit to RRC_CONNECTED state for multicast service, the UE would apply at least one of the following or a possible combination of the following approaches—
a) The UE (100) sets the connection request and/or resume request cause and/or perform connection establishment only as per unicast.
b) The UE (100) sets the connection request and/or resume request cause and (if present and/or applicable) apply randomization approach/back-off and perform connection establishment, only as per multicast.
c) The UE (100) sets the connection request and/or resume request cause and (if present and/or applicable) apply randomization approach/back-off and perform connection establishment, only as per unicast or multicast, whichever has higher priority.
d) The UE (100) sets the connection request and/or resume request cause and (if present and/or applicable) randomization approach/back-off and perform connection establishment, only as per unicast or multicast, whichever provides for earlier access and/or connection establishment.

In an embodiment, MBS/multicast group notification (e.g. group paging, MCCH) may not be configured and/or utilized in certain scenarios/deployments. These may include at least one of the following (but not limited to)
a) Session start and/or session stop based on EPC/USD,
b) Service available in entire PLMN or list of areas provided in on EPC/USD,
c) Frequency used provided in on EPC/USD,
d) Non-MBS supporting RAN node or legacy RAN node, and
e) No support for PTM delivery mode (e.g. lesser user density on cell/area).

Further, UE could limit when to monitor MBS/multicast group notification (e.g. group paging, MCCH) based on above information/configuration, and when monitoring also based on EPC/USD provided information e.g. session start, session stop time.

### Grouping Multicast Sessions:

Further, consider a grouping multicast sessions, the MBS/multicast sessions are grouped and/or sub-grouped together and are indicated for the group/sub-group by the MBS/multicast notification by at least one of the following approaches or a possible combination of the following approaches—
a. At least one PDCCH/DCI bits of the unicast paging,
b. At least one PDCCH/DCI bits of the group paging,
c. At least one PDCCH/DCI bits of the MCCH change notification, and
d. At least one PDCCH/DCI bits of the MCCH.

In an embodiment, the configuration of the grouping and/or sub-group and their mapping to the PDCCH/DCI can be specified or preconfigured (e.g. PDCCH/DCI bit 0 maps to group 0). Alternatively, this mapping is configured to the UEs through dedicated signalling (e.g. RRC reconfiguration, RRC Release, RRC Release with suspend config, Deactivation message, NAS signalling etc.) or broadcast signalling (e.g. SIB or MBS SIB or MCCH itself).

In an embodiment, “N” number of groups/sub-groups configured for the cell/area is informed to the UEs through SIB or MBS SIB or dedicated signalling. Accordingly, the UE can decode and parse relevant PDCCH/DCI bits and determine presence/absence of notification for the group/sub-group of the MBS/multicast session.

In an embodiment, grouping and/sub-grouping of the MBS/multicast sessions is conveyed to the UE through USD (User Service Description) or EPG (Electronic Program Guide) as available through application or service layer and/or configured in the RRC reconfiguration message and/or provided in the Deactivation message (which may be delivered through RRC Release and/or RRC Release with suspend Config etc.) and/or through NAS signalling and/or MAC signalling.

In an embodiment, when the UE determines MBS/multicast notification (e.g. activation) is for a group/sub-group which pertains to the interested multicast session and accordingly, if present, further receives paging message/group paging message/MCCH. If relevant interested MBS session is indicated, UE establishes RRC connection and receives multicast session.

### Addressing the UEs Yet to Join Multicast Session:

In an embodiment, the UEs which have joined multicast session, and for which MBS/multicast session was deactivated in RRC_CONNECTED state and are in RRC_CONNECTED state,
a. Receive MBS/multicast session notification indicating activation and/or dedicated signalling indicating activation;
a. Apply the stored configuration and/or configuration and/or security context/keys received in session notification and/or dedicated signalling for MBS/multicast session.
b. Resume receiving MBS/multicast service.
b. Further, the UEs which have joined multicast session, and for which MBS/multicast session is deactivated in RRC_CONNECTED state and are transitioned to RRC_IDLE and/or RRC_INACTIVE state,
c. Receive MBS/multicast session notification indicating activation;
d. Transit to RRC_CONNECTED state;
a. Apply the stored configuration and/or configuration and/or security context/keys received in session notification and/or dedicated signalling for MBS/multicast session.
b. Resume receiving MBS/multicast service.
e. Further, the UEs which have joined multicast session, and for which MBS/multicast session is deactivated in RRC_CONNECTED state and are transitioned to RRC_IDLE and/or RRC_INACTIVE state,
f. Receive MBS/multicast session notification indicating activation;
a. Apply the stored configuration and/or configuration received in session notification for MBS/multicast session.
b. Resume receiving MBS/multicast service in RRC_IDLE and/or RRC_INACTIVE state.

Further, the UEs which have joined multicast session, and for which MBS/multicast session is deactivated in RRC_IDLE and/or RRC_INACTIVE state,
a. Receive MBS/multicast session notification indicating activation;
a. Apply the stored configuration and/or configuration received in session notification for MBS/multicast session.
b. Resume receiving MBS/multicast service in RRC_IDLE and/or RRC_INACTIVE state.

However, there may be UEs which have not yet joined the multicast session and need to know the status for the multicast service/session (e.g. configured/activated/deactivated, started, stopped etc.). Invention addresses these aspects.

In an embodiment, the UE (100), in RRC_IDLE and/or RRC_INACTIVE and/or RRC_CONNECTED state, which has a new interest in a specific multicast service but has not yet joined the relevant multicast session, sends a MBS/multicast group join request to the network. Once UE has joined the group, UE is informed about the state of multicast service (e.g. configured, activated, deactivated etc.). The UE (100) can also monitor the group notification as specified in earlier description (e.g. session is already in deactivated state, the UE (100) can fall back to RRC_IDLE/RRC_INACTIVE state and/or monitor for group notification).

Further, the UE in RRC_IDLE and/or RRC_INACTIVE state, which has a new interest in a specific multicast service but has not yet joined the relevant multicast session,
a. Receives MCCH message
b. Checks the list of activated MBS session IDs/TMGIs
c. Determines the status of multicast session (e.g. activated/deactivated)
d. If interested multicast session Id is present in the list
a. UE transitions to the RRC_CONNECTED state
b. UE joins the multicast group
e. Else
a. UE continues in RRC_IDLE and/or RRC_INACTIVE state

Therefore, the UE can have early determination and is able to avoid unnecessary state transition to RRC_CONNECTED and then, again fall back to RRC_IDLE or RRC_INACTIVE. Moreover, network may also reject or back-off the UE (100) request to join, when session is not started or not in activated state, which may degrade user experience.

In an embodiment, the UE in RRC_CONNECTED state, which has a new interest in a specific multicast service but has not yet joined the relevant multicast session,
a. Receives MCCH message
b. Checks the list of activated MBS session IDs/TMGIs
c. Determines the status of multicast session (e.g. activated/deactivated)
d. If interested multicast session Id is present in the list
a. UE (100) joins the multicast group
   Addressing UEs which Missed Group Notification:

Further, consider an addressing the UEs which missed the group notification, the UE receives the earliest repetition for MCCH change notification and/or MCCH in the modification period, when UE returns back to service, coverage or connectivity and/or UE (potentially) misses notification.

Further, the UE awaits and attempts to receive unicast paging repetition when UE returns back to service, coverage or connectivity and/or UE (potentially) misses notification. As described earlier, UE may be configured with parameters N and M for unicast paging repetitions for MBS/multicast notification.

Further, the UE (100) awaits and attempts to receive unicast paging repetition in other POs (than that for UE) for the presence of MBS/multicast session notification, when the UE returns back to service, coverage or connectivity and/or UE (potentially) misses notification in its own PO.

Further, the UE (100) awaits and attempts to receive group paging repetition when the UE returns back to service, coverage or connectivity and/or UE (potentially) misses notification. As described earlier, UE (100) may be configured with parameters N and M for group paging repetitions for MBS/multicast notification.

In an embodiment, when the UE (potentially) misses to receive MBS/multicast group notification (e.g. UE encounters decoding error, the UE goes out of coverage temporarily, the UE perform multi-SIM operation and undertakes a switching gap and MBS/multicast group notification falls during switching gap, measurement gaps, autonomous gaps or other reasons for temporary absence), the UE attempts at least one of the following:
a. UE attempts to receive MBS/multicast notification repetition and if no repeated notification is received and/or no repetition of notification is scheduled or configured;
a. If UE were in RRC_IDLE state, UE transits to RRC_CONNECTED state assuming potential notification (e.g. activation) by sending a RRC Connection Request.
b. If UE were in RRC_INACTIVE state, UE transits to RRC_CONNECTED state assuming potential notification (e.g. activation) by sending a RRC Resume Request.
c. If UE were in RRC_CONNECTED state,
i. UE sends notification request to the network; and/or
ii. UE configures stored configurations for MBS/multicast session; and/or
iii. UE awaits dedicated signalling for MBS/multicast session;
b. Alternatively, the UE does nothing and wait for new MBS/multicast notification
c. The UE attempts to receive MBS/multicast notification repetition and if no repeated notification is received and/or no repetition of notification is scheduled or configured;
a. If the UE were in RRC_IDLE state,
i. The UE transits to RRC_CONNECTED state assuming potential notification (e.g. activation) by sending a RRC Connection Request. UE indicates the MBS/multicast session ID/TMGI or cause in RRC Connection Request.
ii. If the MBS/multicast session is still not activated, network may respond with Reject message.
iii. Otherwise, network may provide UE with the configuration through dedicated signalling in RRC_CONNECTED state. Alternatively, UE may also use stored/preserved configuration and/or security context/keys partially or fully.
b. If the UE were in RRC_INACTIVE state,
i. The UE transits to RRC_CONNECTED state assuming potential notification (e.g. activation) by sending a RRC Resume Request. UE indicates the MBS/multicast session ID/TMGI or cause in RRC Resume Request.
ii. If the MBS/multicast session is still not activated, network may respond with Reject message.
iii. Otherwise, network may provide UE with the configuration through dedicated signalling in RRC_CONNECTED state. Alternatively, UE may also use stored/preserved configuration and/or security context/keys partially or fully.
c. If the UE were in RRC_CONNECTED state, one of the options may be utilized
i. Option a: the UE sends a request message to network with assuming potential notification (e.g. activation). If the MBS/multicast session is still not activated, network may respond with Reject message. Otherwise, network may provide UE with the configuration through dedicated signalling in RRC_CONNECTED state. Alternatively, UE may also use stored/preserved configuration and/or security context/keys partially or fully.
ii. Option b: the UE waits for dedicated signalling for activation and does no action
d. Alternatively, the UE does nothing and wait for new MBS/multicast notification and/or unicast paging to transition to RRC_CONNECTED state.
e. The UE receives MCCH message (e.g. in the earliest repetition in the modification period) and determines the list of MBS/multicast sessions (e.g. list of activated sessions). UE determines if it has missed any notification. If so, UE transits to appropriate state to start/stop receive and/or release MBS/multicast session.
a. If the UE were in RRC_IDLE state, the UE transits to RRC_CONNECTED state by sending a RRC Connection Request. The UE indicates the MBS/multicast session ID/TMGI or cause in RRC Connection Request.
b. If the UE were in RRC_INACTIVE state, the UE transits to RRC_CONNECTED state by sending a RRC Resume Request. The UE indicates the MBS/multicast session ID/TMGI or cause in RRC Resume Request.
c. If the UE were in RRC_CONNECTED state,
i. The UE configures stored configurations and/or security context/keys for MBS/multicast session; and/or
ii. The UE applies the configurations received in MCCH for MBS/multicast session; and/or
iii. The UE awaits dedicated signalling for MBS/multicast session;

In an embodiment, while doing MUSIM operation, priority for MBS notification reception is set high. That is, the UE considers avoiding MUSIM gap to handle other SIM lower priority activities given the higher priority of the MBS notification reception and thereby, prevent/reduce the loss of MBS notification as much as possible. Alternatively, MUSIM gaps are configured considering the MBS/multicast session notification occasions.

In an embodiment, MBS/multicast notification and/or dedicating signalling message (e.g. conveying activation) informs UE also the PDCP and/or RLC PDU initial sequence number (e.g. first sequence number after activation like “0” or some SN “x” or set to/as per SN of first PDU received or resumption of SN from deactivation state). In case, UE misses notification message and/or re-joins the activated session late,
a. UE receives MBS/multicast session after receiving dedicated signalling message; and/or
b. UE applies the PDCP and/or RLC PDU initial sequence number related information provided in dedicated signalling; or
c. UE applies PDCP and/or RLC initial SN set to or as per SN of the first PDU received; and/or

### Addressing Multicast Session Stop and Release Scenarios:

Consider an addressing the multicast session stop and release/deconfigure scenarios,
a. Upon MBS/multicast notification reception (e.g. RRC_IDLE/RRC_INACTIVE/RRC_CONNECTED state) and/or dedicated signalling (e.g. in RRC_CONNECTED state), When it includes release/deconfigure of one or more MBS/multicast session, UE undertakes at least one of the following operations
a. When UE is RRC_CONNECTED and session is in “activated” state
i. PDCP entity reestablishment/release pertaining to MBS/multicast session
ii. PTM and/or/PTP RLC bearer release pertaining to MBS/multicast session
iii. Logical channel(s) release pertaining to MBS/multicast session
iv. Clear HARQ buffer(s)/process/processes pertaining to MBS/multicast session
v. MAC reset, if this is last MBS/multicast session and no other PTM/PTP/unicast service is active
vi. Transit to RRC_IDLE or RRC_INACTIVE state, if there is no PTM/PTP/unicast bearer is active and/or an inactivity or Data-Inactivity timer has expired; otherwise continues in RRC_CONNECTED state
b. Upon MBS/multicast notification reception (e.g. RRC_IDLE/RRC_INACTIVE/RRC_CONNECTED state) and/or dedicated signalling (e.g. in RRC_CONNECTED state), When it includes release/deconfigure of one or more MBS/multicast session, the UE undertakes at least one of the following operations; and/or
c. An Inactivity timer is configured by network and/or UE operates an Inactivity timer. The UE starts Inactivity timer on receiving deactivation for MBS/multicast session and when Inactivity timer is expired with no activation for the MBS/multicast session (i.e. Inactivity timer is stopped upon activation), the UE undertakes at least one of the following operations;
a. When the UE is RRC_CONNECTED and session is in “deactivated” state
i. Release PDCP entity pertaining to MBS/multicast session
ii. PTM and/or/PTP RLC bearer release pertaining to MBS/multicast session
iii. Logical channel(s) release pertaining to MBS/multicast session
iv. Delete the stored/preserved configuration for MBS/multicast session, if any
v. Clear HARQ buffer(s)/process/processes pertaining to MBS/multicast session
vi. MAC reset, if this is last MBS/multicast session and no other PTM/PTP/unicast service is active
vii. Transit to RRC_IDLE or RRC_INACTIVE state, if there is no PTM/PTP/unicast bearer is active and/or an inactivity or Data-Inactivity timer has expired; otherwise continues in RRC_CONNECTED state
b. When the UE is RRC_IDLE and/or RRC_INACTIVE and session is in “deactivated” state
i. Stop monitoring for group notification for this MBS/multicast session ID
ii. Delete the MBS session ID for the deactivated MBS/multicast session
iii. Delete the stored/preserved configuration and/or security context/keys for MBS/multicast session, if any

In an embodiment, inactivity timer configuration is per MBS/multicast session or per UE. Network configures inactivity for the MBS session or UE in the dedicated signalling and/or group notification message (e.g. paging, MCCH) and/or SIB/MBS SIB or through deactivation related signalling message or through RRC Release/RRC Release with suspend configuration or NAS signalling.

In an embodiment, the UE sends the leaving indication to the network when UE is in RRC_IDLE/RRC_INACTIVE/RRC_CONNECTED state. After this, the UE loses interest in MBS/multicast session and/or UE terminates or about to terminate the MBS/multicast session. This can be employed in scenarios when—
a. MBS/multicast was in activated/configured state and/or UE was receiving MBS/multicast session; or
b. MBS/multicast session was in deactivated/configured state and/or UE was monitoring for group notification or dedicated signalling.

Alternatively, the UE implicitly leave the MBS/multicast session and provide no leave indication to the network

In an embodiment, network sends unicast paging for bringing UE to RRC_CONNECTED state, and then releasing of the multicast session in the RRC_CONNECTED state with dedicated signalling.

### BWP Switching on Receiving MBS/Multicast Notification:

In an embodiment, UE (100) undertakes BWP switching operation to the pertinent MBS BWP indicated for the MBS/multicast session in the notification message, when UE needs to receive multicast in RRC_IDLE or RRC_INACTIVE state.

In an embodiment, UE (100) in RRC_IDLE/RRC_INACTIVE state, indicates to the network, the pertinent MBS BWP informed for the MBS/multicast session in the notification message, when UE needs to receive multicast in RRC_CONNECTED state. UE indicates the BWP in the RRC connection request/resume request or MBS interest indication or UE assistance information.

In an embodiment, UE (100) in RRC_CONNECTED state, undertakes BWP switching operation to the pertinent MBS BWP indicated for the MBS/multicast session in the notification message and/or dedicated signalling, when UE needs to receive multicast in RRC_CONNECTED state.

In an embodiment, network switches the BWP of the UE when the pertinent MBS/multicast session(s) are deactivated (e.g. move to smaller BWP or another BWP more suitable for UE existing services or power performance etc.) and/or switches the BWP of the UE when the pertinent MBS/multicast session(s) are activated (e.g. to support MBS/multicast session). UE is informed for the BWP switching in dedicated signalling (e.g. RRC reconfiguration, MAC CE, PDCCH DCI etc.) either separately or together with the deactivation/activation of the MBS/multicast session.

In an embodiment, in certain scenarios, UE may locally suspend the MBS/multicast session (e.g. when UE is not able to operate the MBS BWP and/or not able to operate MBS session with unicast service and/or has temporarily lost interest/involvement in MBS session but does not like to unjoin), UE performs a local suspension of MBS session. In RRC_IDLE and RRC_INACTIVE (if supporting Multicast reception) and also RRC_CONNECTED PTM mode, UE can skip receiving the MBS/multicast session packets. However, in RRC_CONNECTED PTP mode, UE needs to inform the network for the PTP bearer suspension and resumption in order to achieve local suspension of MBS/multicast session. Further, if UE informs also for the PTM mode suspension to the network, network can suitably configure/switch the BWP for the UE.

### Operation in Non-MBS Supporting RAN Node

In an embodiment, UE which is in the cell/area under the non-MBS supporting RAN node, is informed through legacy unicast paging when there is MBS/multicast session notification (e.g. activation), for which UE has already joined the multicast session group. Further, in an approach paging “cause” value can be set to “MBS/multicast”. Further, in approach, paging identity can be set to a different/alternate UE identity (i.e. an alternate reserved UE identity is used as group identity for MBS session notification) which is mapped to the MBS/multicast session. Thereby, UE gets to know the MBS/multicast session notification. For this purpose, mapping information is specified or pre-configured/configured to the UE through NAS and/or RRC signalling.

In an embodiment, alternate paging identity is monitored by the interested UEs as per the PO/PF calculations for the alternate paging identity. Effectively, UE needs to monitor its own legacy paging occasion for paging message and also paging occasion for multicast session notification. Paging PDCCH is addressed to P-RNTI.

In an embodiment, alternate paging identity is only used by the interested UEs to read a paging record carrying the alternate paging identity for the multicast session notification. However, PO/PF calculations for the paging remains the same as the legacy unicast paging for the UE identity. Effectively, UE needs to monitor only its own legacy paging occasion and additionally determine presence of a paging record pertaining to multicast session notification in the paging message. Paging PDCCH is addressed to P-RNTI.

In an embodiment, UEs (100) which are under non-MBS supporting RAN nodes are provided notification related to MBS/multicast session release/deconfigure, so that they can stop monitoring for MBS/multicast notification (e.g. alternate paging identity or paging cause etc.) and conserve their power and processing. In an approach, alternative paging identity are mapped and informed which also conveys “activation” and/or “release/deconfigure” for the MBS multicast session. In an approach, paging “cause” also conveys “activation” and/or “release/deconfigure” for the MBS multicast session.

In an embodiment, paging capacity limitation is determined by the network when a large number of UEs needs to be paged through legacy unicast paging approach for MBS/multicast notification. In this case, network may redirect the UE to different cell/frequency (e.g. RRC release with redirection message) or alter the cell reselection or frequency prioritization parameters to disperse the UEs to different cells/frequencies.

FIG. 2b illustrates various hardware elements of the UE (100), according to the embodiments as disclosed herein. In an embodiment, the UE (100) includes a processor (110), a communicator (120), a memory (130), and a multicast session notification handling controller (140). The processor (110) is coupled with the communicator (120), the memory (130) and the multicast session notification handling controller (140).

The multicast session notification handling controller (140) establishes the multicast session with the network apparatus (400). The multicast session is associated with the MBS session ID or the TMGI. Further, the multicast session notification handling controller (140) detects that the UE (100) transits from the RRC connected state to one of the RRC idle state or the RRC inactive state.

In an embodiment, the multicast session notification handling controller (140) receives the RRC reconfiguration with the MRB release conveying deactivation of the multicast session associated with the MBS session ID or the TMGI, and one of a RRC release and a RRC release with suspend configuration or has an expiry of data inactivity timer, and transition from the RRC connected state to one of the RRC idle state or the RRC inactive state.

In another embodiment, the multicast session notification handling controller (140) receives the group notification message from the network apparatus (400) for deactivation of the multicast session associated with the MBS session ID or the TMGI, and one of a RRC release and a RRC release with suspend configuration, or has an expiry of data inactivity timer, and transitions from the RRC connected state to one of the RRC idle state or the RRC inactive state. The group notification message for deactivation of the multicast session is received on at least one of unicast POs, group paging with common POs, and a MCCH change notification.

Further, the multicast session notification handling controller (140) determines whether the UE (100) has joined at least one multicast session which is non-activated in response detecting that the UE (100) is in one of the RRC idle state or the RRC inactive state. In an embodiment, the multicast session notification handling controller (140) monitors for paging for a group notification message for activation of the multicast session associated with the MBS session ID or the TMGI through at least one of unicast POs, group paging with common POs, and a MCCH change notification in response to determining that the UE (100) has joined the at least one multicast session which is non-activated.

In an embodiment, the multicast session notification handling controller (140) monitors same PF and PO as that of unicast paging and receives and decodes paging message with P-RNTI. Further, the multicast session notification handling controller (140) parses and determines presence or absence of the MBS session ID or the TMGI in the pagingGroupList in the paging message for at least one of the multicast session associated with the UE (100) which the UE (100) has joined and is non-activated, where the pagingGroupList is a list of MBS session IDs or TMGIs of multicast sessions which are activated. Further, the multicast session notification handling controller (140) detects the activation of the MBS session in response to determining the presence of MBS session ID or the TMGI in the pagingGroupList in the paging message for at least one of the multicast session associated with the UE (100) which the UE (100) has joined and is non-activated.

In another embodiment, the multicast session notification handling controller (140) monitors a common PF and PO by all UEs that is different than that of unicast PF and PO of the respective UEs and receives and decodes the paging message with one of the P-RNTI or the G-RNTI/G-CS-RNTI of the concerned MBS session. Further, the multicast session notification handling controller (140) parses and determines the presence or absence of MBS session ID or the TMGI in the pagingGroupList in the paging message for at least one of the multicast session associated with the UE (100) which the UE (100) has joined and is non-activated. The pagingGroupList is a list of MBS session IDs or TMGIs of multicast sessions which are activated. Further, the multicast session notification handling controller (140) detects activation of the MBS session in response to determining the presence of MBS session ID or the TMGI in the pagingGroupList in the paging message for at least one of the multicast session associated with the UE (100) which the UE (100) has joined and is non-activated.

In another embodiment, the multicast session notification handling controller (140) monitors a MCCH change notification on DCI on the PDCCH. Further, the multicast session notification handling controller (140) determines presence or absence of the MCCH change notification that indicates the change of the activation list of at least one MBS session in the MCCH. Further, the multicast session notification handling controller (140) receives and determines if the MCCH consists activation for at least one MBS session associated with the UE (100) which the UE (100) has joined and is non-activated, in response to determining the presence of the MCCH change notification.

In another embodiment, the multicast session notification handling controller (140) skips to monitor for paging for the group notification message for activation of the multicast session associated with the MBS session ID or the TMGI on at least one of unicast POs, group paging with common POs, and a MCCH change notification in response to determining that the UE (100) has not joined the at least one multicast session which is non-activated.

Further, the multicast session notification handler (140) receives the group notification message for activation of the multicast session associated with the MBS session ID or the TMGI on at least one of the unicast POs, the group paging with common POs, and the MCCH change notification. Further, the multicast session notification handler (140) forwards to an upper layer the MBS session ID or the TMGI for activation of the multicast session in response to receiving the group notification message for activation of the multicast session associated with the MBS session ID or the TMGI. Further, the multicast session notification handler (140) stops monitor paging for the group notification message for activation of the multicast session associated with the MBS session ID or the TMGI on at least one of unicast POs, the group paging with common POs, and the MCCH change notification. Further, the multicast session notification handler (140) initiates the RRC connection setup or a RRC resume procedure based on the RRC idle state or the RRC inactive state. Further, the multicast session notification handler (140) transitions the UE (100) from the RRC idle state or the RRC inactive state to the RRC connected state. Further, the multicast session notification handler (140) receives the RRC reconfiguration with the configuration for the activated multicast session from the network apparatus (400).

Further, the multicast session notification handler (140) receives the group notification message for releasing the multicast session associated with the MBS session ID or the TMGI on at least one of the unicast POs, the group paging with common POs, and the MCCH change notification. Further, the multicast session notification handler (140) releases the multicast session and stops to monitor the paging for the group notification message for activation of the multicast session associated with the MBS session ID or the TMGI on at least one of unicast POs, the group paging with common POs, and the MCCH change notification.

Further, the multicast session notification handler (140) stores a configuration of the multicast session before transitioning from the RRC connected state to one of the RRC idle state or the RRC inactive state. Further, the multicast session notification handler (140) receives the group notification message for activation of the multicast session associated with the MBS session ID or the TMGI on at least one of the unicast POs, the group paging with common POs, and the MCCH change notification. Further, the multicast session notification handler (140) forwards to an upper layer the MBS session ID or the TMGI for activation of the multicast session in response to receiving the group notification message for activation of the multicast session associated with the MBS session ID or the TMGI. Further, the multicast session notification handler (140) stops the monitoring of paging for the group notification message for activation of the multicast session associated with the MBS session ID or the TMGI on at least one of unicast POs, the group paging with common POs, and the MCCH change notification. Further, the multicast session notification handler (140) initiates the RRC connection setup or a RRC resume procedure based on the UE (100) is in the RRC idle state or the RRC inactive state. Further, the multicast session notification handler (140) transitions the UE (100) from one of the RRC idle state or the RRC inactive state to the RRC connected state and restores the multicast session based on the stored configuration of the multicast session.

Further, the multicast session notification handler (140) applies a randomization for an access attempt by the UE (100) for back-off or re-attempting the access to the multicast session.

Further, the multicast session notification handler (140) determines whether the PEI indicates presence of the paging. Further, the multicast session notification handler (140) receives the paging irrespective to determining that the PEI indicates presence of the paging or the PEI does not indicate presence of the paging when the UE (100) has joined at least one MBS session which is non-activated. Alternately, the multicast session notification handler (140) receives the paging in response to determining that the PEI indicates presence of the paging and UE (100) has not joined at least one MBS session which is non-activated. Alternately, the multicast session notification handler (140) skip to receive of the paging in response to determining that the PEI does not indicate presence of the paging and the UE (100) has not joined at least one MBS session which is non-activated.

Further, the multicast session notification handler (140) determines whether the group notification message for the MBS session comprises or pertains to an access category and at least one access identity. In response to determining that the group notification message for the MBS session comprises or pertains to the access category and the at least one access identity, the multicast session notification handler (140) applies the UAC mechanism for the MBS session to establish or resume a RRC connection with the network apparatus (400). In response to determining that the group notification message for the MBS session does not comprise or pertain to the access category and the at least one access identity, the multicast session notification handler (140) establishes or resumes the RRC connection with the network apparatus (400) without applying the UAC mechanism for the MBS session.

Further, the multicast session notification handler (140) receives the congestion status for the MBS session broadcasted by the network apparatus (400). The congestion status is broadcasted in one of a system information block, a MCCH information message and a paging message. Further, the multicast session notification handler (140) establishes or resumes the RRC connection with the network apparatus (400) when the congestion status for the MBS session is not indicated. Further, the multicast session notification handler (140) skips establish or resume of a RRC connection with the network apparatus (400) when the congestion status for the MBS session is indicated.

Further, the multicast session notification handler (140) stores a configuration of the multicast session before transitioning from the RRC connected state to one of the RRC idle state or the RRC inactive state. Further, the multicast session notification handler (140) receives the group notification message for activation of the multicast session associated with the MBS session ID or the TMGI on at least one of the unicast POs, the group paging with common POs, and the MCCH change notification. Further, the multicast session notification handler (140) applies the stored configuration and resumes receiving MBS service in one of the RRC idle state or the RRC inactive state.

Further, the multicast session notification handler (140) sends the message indicating a capability of the UE (100), wherein the message comprises at least one of a support for MBS in a RRC state or multiple RRC states of the UE (100), a support for MBS notification approach or approaches of the UE (100), a support for one or multiple Bandwidth Parts (BWPs) simultaneously or not, a support for parallel reception for unicast and MBS and related approach comprising at least one of Time Division Multiplexing (TDM), Frequency Division Multiplexing (FDM), Carrier aggregation, and dual connectivity, and a support for one or more simultaneous G-RNTIs/G-CS-RNTIs. The message can be, for example, but not limited to the UE capability information message, the UE assistance information message, the RRC Connection request message, the RRC Resume request message, the RRC setup complete message, and the MBS interest indication message.

The multicast session notification handling controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2b shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 2c illustrates various hardware elements of the network apparatus (400), according to the embodiments as disclosed herein. In an embodiment, the network apparatus (400) includes a processor (410), a communicator (420), a memory (430), and a multicast session notification handling controller (440). The processor (410) is coupled with the communicator (420), the memory (430) and the multicast session notification handling controller (440).

The multicast session notification handling controller (440) detects the multicast session with the UE (100), where the multicast session is associated with the MBS session ID or the TMGI. Further, multicast session notification handling controller (440) sends one of: a RRC reconfiguration with the MRB release conveying deactivation of the multicast session associated with the MBS session ID or the TMGI, and the group notification message to the UE (100) for deactivation of the multicast session associated with the MBS session ID or the TMGI on at least one of unicast POs, group paging with common POs, and the MCCH change notification.

Further, the multicast session notification handling controller (440) detects that the UE (100) is transitioned from the connected state to one of the idle state or the inactive state. Further, the multicast session notification handling controller (440) sends the group notification message to the UE (100) for activation of the multicast session associated with the MBS session ID or the TMGI on at least one of the unicast POs, the group paging with the common POs, and the MCCH change notification.

Further, the multicast session notification handling controller (440) performs the RRC connection setup or the RRC resume procedure to transition the UE from one of the RRC idle state and the RRC inactive state to the RRC connected state. Further, the multicast session notification handling controller (440) sends the RRC reconfiguration with the configuration for the activated multicast session to the UE (100).

The multicast session notification handling controller (440) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Although the FIG. 2c shows various hardware components of the network apparatus (400) but it is to be understood that other embodiments are not limited thereon. In other embodiments, the network apparatus (400) may include less or more number of components. Further, the labels or names of the components are used only for illustrative purpose and does not limit the scope of the invention. One or more components can be combined together to perform same or substantially similar function in the network apparatus (400).

FIG. 3 is a flow chart (S300) illustrating a method, implemented by the UE (100), for the multicast session notification signalling and procedure in the wireless network (1000), according to the embodiments as disclosed herein.

At S302, the UE (100) establishes the multicast session with the network apparatus (400). The multicast session is associated with the MBS session ID or the TMGI. At S304, the UE (100) detects that the UE (100) transits from the RRC connected state to one of the RRC idle state or the RRC inactive state. At S306, the UE (100) determines whether the UE (100) has joined at least one the multicast session which is non-activated in response detecting that the UE (100) is in one of the RRC idle state or the RRC inactive state.

In response to determining that the UE (100) has joined the at least one multicast session which is non-activated then, at S308, the UE (100) monitors for paging for the group notification message for activation of the multicast session associated with the MBS session ID or the TMGI through at least one of unicast POs, group paging with common POs, and the MCCH change notification. In response to determining that the UE (100) has not joined the at least one multicast session which is non-activated then, at S310, the UE (100) skips monitoring for paging for the group notification message for activation of the multicast session associated with the MBS session ID or the TMGI on at least one of the unicast POs, the group paging with common POs, and the MCCH change notification.

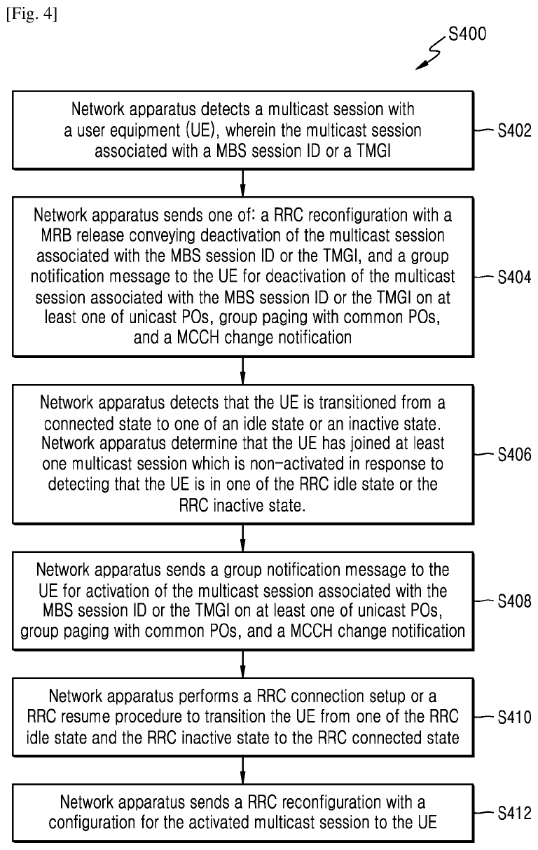

FIG. 4 is a flow chart (S400) illustrating a method, implemented by the network apparatus (400), for the multicast session notification signalling and procedure in the wireless network (1000), according to the embodiments as disclosed herein.

At S402, the network apparatus (400) detects the multicast session with the UE (100), where the multicast session is associated with the MBS session ID or the TMGI. At S404, the network apparatus (400) sends one of: a RRC reconfiguration with the MRB release conveying deactivation of the multicast session associated with the MBS session ID or the TMGI, and the group notification message to the UE (100) for deactivation of the multicast session associated with the MBS session ID or the TMGI on at least one of unicast POs, group paging with common POs, and the MCCH change notification.

At S406, the network apparatus (400) detects that the UE (100) is transitioned from the connected state to one of the idle state or the inactive state. The network apparatus (400) determines that the UE (100) has joined at least one multicast session which is non-activated in response to detecting that the UE (100) is in one of the RRC idle state or the RRC inactive state. At S408, the network apparatus (400) sends the group notification message to the UE (100) for activation of the multicast session associated with the MBS session ID or the TMGI on at least one of the unicast POs, the group paging with the common POs, and the MCCH change notification.

At S410, the network apparatus (400) performs the RRC connection setup or the RRC resume procedure to transition the UE from one of the RRC idle state and the RRC inactive state to the RRC connected state. At S412, the network apparatus (400) sends the RRC reconfiguration with the configuration for the activated multicast session to the UE (100).

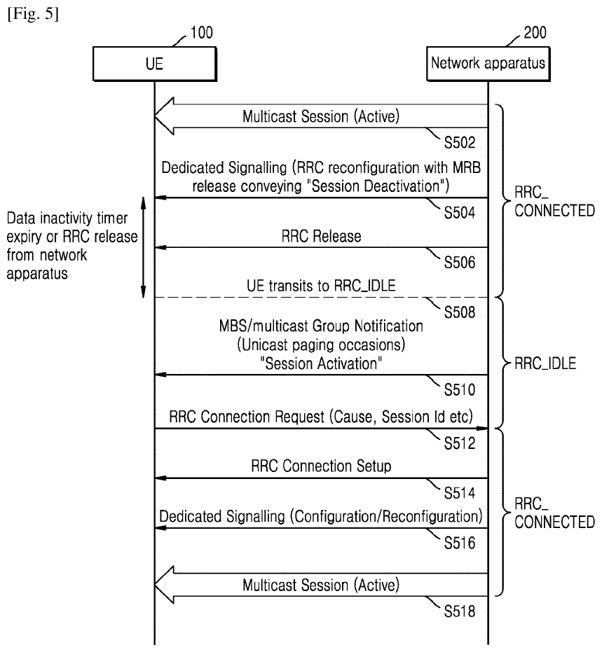

FIG. 5 is a sequence diagram illustrating a method for the multicast session notification signalling and procedure in the wireless network (1000) based on the group notification in the RRC_IDLE state using the unicast POs, according to the embodiments as disclosed herein.

At S502, the multicast session is active between the UE (100) and the network apparatus (400). At S504, the network apparatus (400) sends the dedicated signalling (including the RRC reconfiguration with the MRB release conveying “Session Deactivation”) to the UE (100). At S506, the network apparatus (400) sends the RRC release to the UE (100). At S508, the UE (100) transits to the RRC_IDLE state, when the UE (100) determines there is the data inactivity timer expiry or the RRC release is received from the network apparatus (400).

At S510, the network apparatus (400) sends the MBS/multicast Group Notification on the Unicast paging occasions) conveying “Session Activation” to the UE (100). At S512, the UE (100) sends the RRC connection request (including the cause, session Id etc) to the network apparatus (400). At S514, the network apparatus (400) sends RRC connection setup to the UE (100). At S516, the network apparatus (400) sends the dedicated Signalling (including the configuration information/Reconfiguration information) to the UE (100). At S518, the multicast session is again active between the UE (100) and the network apparatus (400).

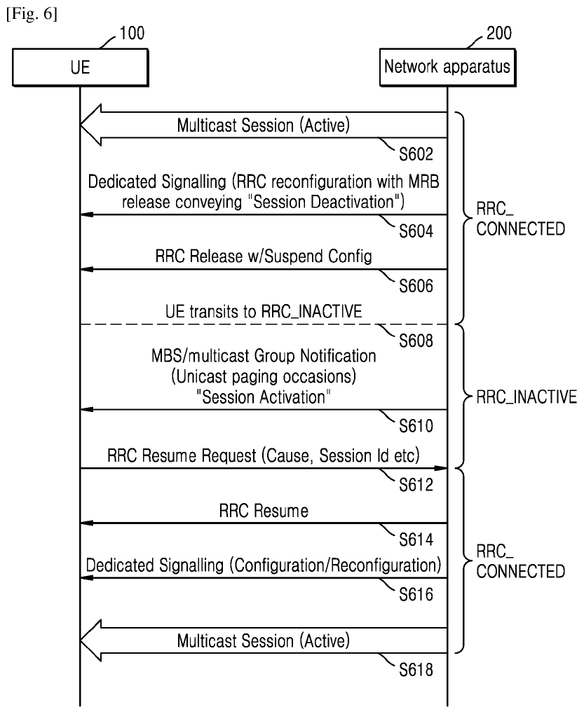

FIG. 6 is a sequence diagram illustrating a method for the multicast session notification signalling and procedure in the wireless network (1000) based on the group notification in the RRC_INACTIVE state using the unicast POs, according to the embodiments as disclosed herein.

At S602, the multicast session is active between the UE (100) and the network apparatus (400). At S604, the network apparatus (400) sends the dedicated signalling (including the RRC reconfiguration with the MRB release conveying “Session Deactivation”) to the UE (100). At S606, the network apparatus (400) sends the RRC release with suspend Config to the UE (100). At S608, the UE (100) transits to the RRC_INACTIVE state.

At S610, the network apparatus (400) sends the MBS/multicast Group Notification (on the Unicast paging occasions) conveying “Session Activation” to the UE (100). At S612, the UE (100) sends the RRC resume request (including the cause, session Id etc) to the network apparatus (400). At S614, the network apparatus (400) sends RRC resume to the UE (100). At S616, the network apparatus (400) sends the dedicated signalling (including the configuration information/Reconfiguration information) to the UE (100). At S618, the multicast session is again active between the UE and the network apparatus (400).

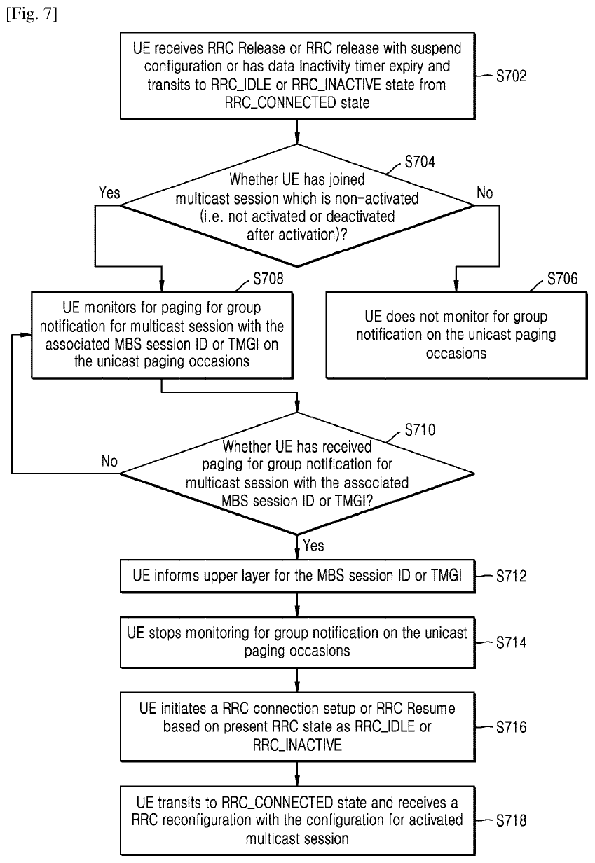

FIG. 7 is a flow chart (S700) illustrating a method, implemented by the UE (100), for the multicast session notification signalling and procedure in the wireless network (1000) when the UE (100) receives the RRC release or the RRC release with suspend configuration or has the data inactivity timer expiry and transits to the RRC_IDLE or RRC_INACTIVE state from the RRC_CONNECTED state, according to the embodiments as disclosed herein.

At S702, the UE (100) receives the RRC release or the RRC release with suspend configuration or has the data inactivity timer expiry and transits to the RRC_IDLE or RRC_INACTIVE state from RRC_CONNECTED state. At S704, the UE (100) determines whether the UE (100) has joined the multicast session which is non-activated (i.e., not yet activated or deactivated after activation). In response to determining that the UE (100) has not joined the multicast session which is non-activated then, at S706, the UE (100) does not monitor for group notification on the unicast paging occasions. In response to determining that the UE (100) has joined multicast session which is non-activated then, at S708, the UE (100) monitors for paging for group notification for multicast session with the associated MBS session ID or TMGI on the unicast Paging Occasions.

At S710, the UE (100) determines that the UE (100) has received the paging for group notification for multicast session with the associated MBS session ID or TMGI. In response to receiving the paging for group notification for the multicast session with the associated MBS session ID or TMGI then, at S712, the UE (100) informs the upper layer for the MBS session ID or TMGI. At S714, the UE (100) stops monitoring for group notification on the unicast paging occasions. At S716, the UE (100) initiates the RRC connection setup or RRC Resume based on present RRC state as RRC_IDLE or RRC_INACTIVE. At S718, the UE (100) transits to the RRC_CONNECTED state and receives the RRC reconfiguration with the configuration for activated multicast session.

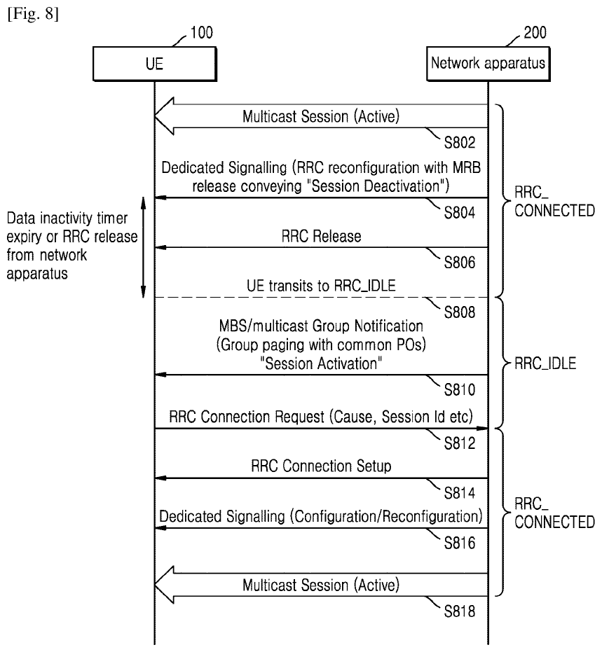

FIG. 8 is a sequence diagram illustrating a method for the multicast session notification signalling and procedure in the wireless network (1000) based on the group notification in the RRC_IDLE state using the common POs, according to the embodiments as disclosed herein.

At S802, the multicast session is active between the UE (100) and the network apparatus (400). At S804, the network apparatus (400) sends the dedicated signalling (including the RRC reconfiguration with the MRB release conveying “Session Deactivation”) to the UE (100). At S806, the network apparatus (400) sends the RRC release to the UE (100). At S808, the UE (100) transits to the RRC_IDLE state, when the UE (100) determines there is the data inactivity timer expiry or the RRC release is received from the network apparatus (400).

At S810, the network apparatus (400) sends the MBS/multicast Group Notification (including the Group paging with common POs) conveying “Session Activation” to the UE (100). At S812, the UE (100) sends the RRC connection request (including the cause, session Id etc.) to the network apparatus (400). At S814, the network apparatus (400) sends RRC connection setup to the UE (100). At S816, the network apparatus (400) sends the dedicated signalling (including the configuration information/Reconfiguration information) to the UE (100). At S818, the multicast session is again active between the UE and the network apparatus (400).

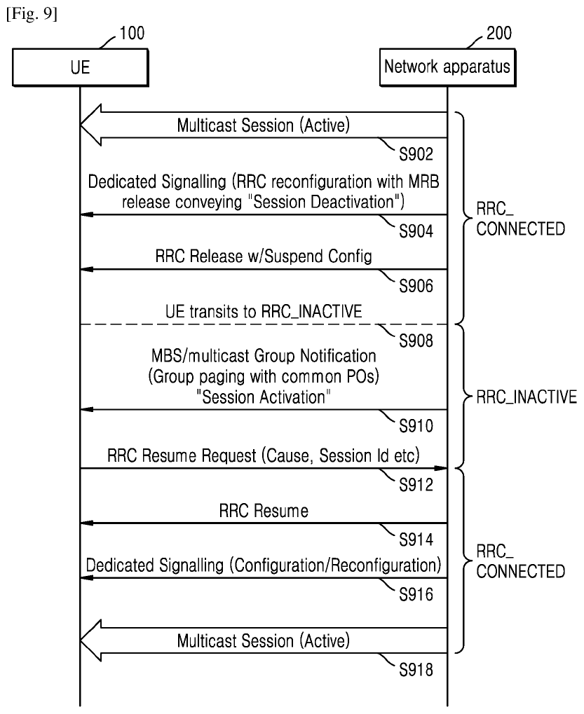

FIG. 9 is a sequence diagram illustrating a method for the multicast session notification signalling and procedure in the wireless network (1000) based on the group notification in the RRC_INACTIVE state using the common POs, according to the embodiments as disclosed herein.

At S902, the multicast session is active between the UE (100) and the network apparatus (400). At S904, the network apparatus (400) sends the dedicated signalling (including the RRC reconfiguration with the MRB release conveying “Session Deactivation”) to the UE (100). At S906, the network apparatus (400) sends the RRC release with suspend Config to the UE (100). At S908, the UE (100) transits to the RRC_INACTIVE state.

At S910, the network apparatus (400) sends the MBS/multicast Group Notification (including the Group paging with common POs) conveying “Session Activation” to the UE (100). At S912, the UE (100) sends the RRC resume request (including the cause, session Id etc.) to the network apparatus (400). At S914, the network apparatus (400) sends RRC resume to the UE (100). At S916, the network apparatus (400) sends the dedicated signalling (including the configuration information/Reconfiguration information) to the UE (100). At S918, the multicast session is again active between the UE and the network apparatus (400).

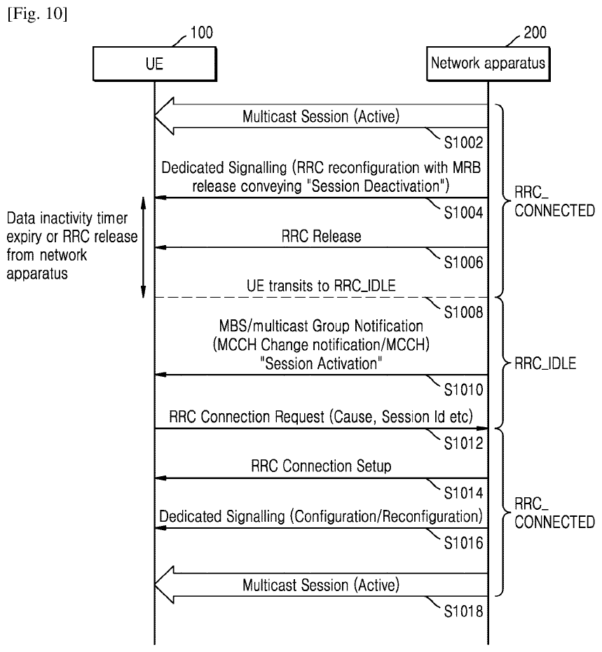

FIG. 10 is a sequence diagram illustrating a method for the multicast session notification signalling and procedure in the wireless network (1000) based on the group notification in the RRC_IDLE state using the MCCH change notification and/or MCCH, according to the embodiments as disclosed herein.

At S1002, the multicast session is active between the UE (100) and the network apparatus (400). At S1004, the network apparatus (400) sends the dedicated signalling (including the RRC reconfiguration with the MRB release conveying “Session Deactivation”) to the UE (100). At S1006, the network apparatus (400) sends the RRC release to the UE (100). At S1008, the UE (100) transits to the RRC_IDLE state, when the UE (100) determines there is the data inactivity timer expiry or the RRC release is received from the network apparatus (400).

At S1010, the network apparatus (400) sends the MBS/multicast Group Notification (including the MCCH Change notification/MCCH) conveying “Session Activation” to the UE (100). At S1012, the UE (100) sends the RRC connection request (including the cause, session Id etc) to the network apparatus (400). At S1014, the network apparatus (400) sends the RRC connection setup to the UE (100). At S1016, the network apparatus (400) sends the dedicated signalling (including the configuration information/Reconfiguration information) to the UE (100). At S1018, the multicast session is again active between the UE and the network apparatus (400).

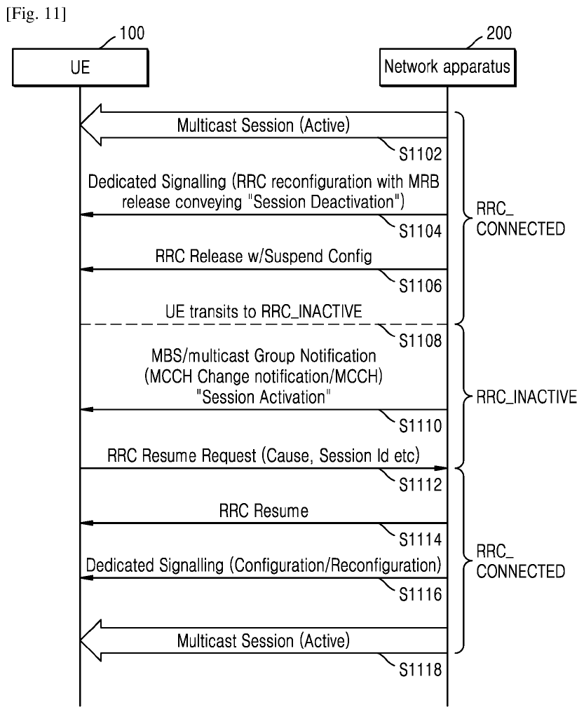

FIG. 11 is a sequence diagram illustrating a method for the multicast session notification signalling and procedure in the wireless network (1000) based on the group notification in the RRC_INACTIVE state using the MCCH change notification and/or MCCH, according to the embodiments as disclosed herein.

At S1102, the multicast session is active between the UE (100) and the network apparatus (400). At S1104, the network apparatus (400) sends the dedicated signalling (including the RRC reconfiguration with the MRB release conveying “Session Deactivation”) to the UE (100). At S1106, the network apparatus (400) sends the RRC release with suspend Config to the UE (100). At S1108, the UE (100) transits to the RRC_INACTIVE state.

At S1110, the network apparatus (400) sends the MBS/multicast Group Notification (including MCCH Change notification/MCCH) “Session Activation” to the UE (100). At S1112, the UE (100) sends the RRC resume request (including the cause, session Id etc) to the network apparatus (400). At S1114, the network apparatus (400) sends RRC resume to the UE (100). At S1116, the network apparatus (400) sends the dedicated signalling (including the configuration information/Reconfiguration information) to the UE (100). At S1118, the multicast session is again active between the UE and the network apparatus (400).

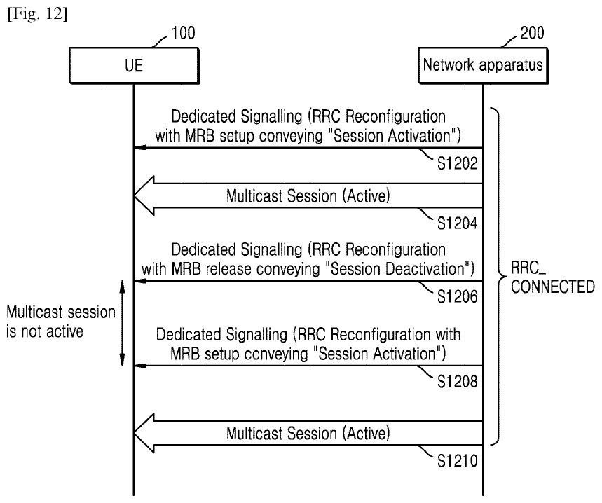

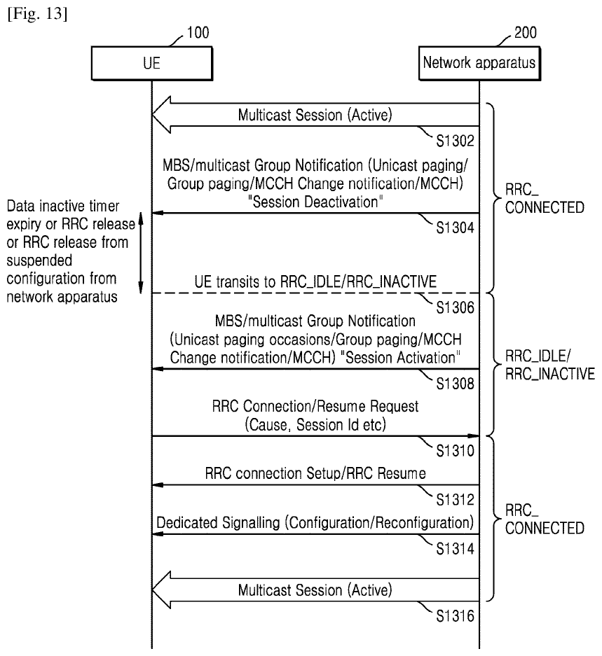

FIG. 12 and FIG. 13 are sequence diagrams illustrating a method for the multicast session notification signalling and procedure in the wireless network (1000) based on the group notification in the RRC_CONNCTED state, according to the embodiments as disclosed herein.

As shown in the FIG. 12, at S1202, the network apparatus (400) sends the dedicated signalling (including RRC Reconfiguration with the MRB setup conveying “session activation”) to the UE (100). At S1204, the multicast session is active between the UE (100) and the network apparatus (400). At S1206, the network apparatus (400) sends the dedicated signalling (including the RRC reconfiguration with the MRB release conveying “Session Deactivation”) to the UE (100). At S1208, the network apparatus (400) sends the dedicated signaling (including the RRC Reconfiguration with MRB setup conveying “session activation”) to the UE (100). The multicast session is not active between the step 1206 and 1208. At S1210, the multicast session is again active between the UE (100) and the network apparatus (400).

As shown in the FIG. 13, at S1302, the multicast session is active between the UE (100) and the network apparatus (400). At S1304, the network apparatus (400) sends the MBS/multicast Group Notification (including Unicast paging/Group paging/MCCH Change notification/MCCH) “Session deactivation” to the UE (100). At S1306, the UE (100) transits to the RRC_IDLE or the RRC_INACTIVE, when the UE (100) determines there is the data inactivity timer expiry or the RRC release or RRC release with suspend configuration is received from the network apparatus (400).

At S1308, network apparatus (400) sends the MBS/multicast Group Notification (including the Unicast paging occasions/Group paging/MCCH Change notification/MCCH) “Session Activation” to the UE (100). At S1310, the UE (100) sends the RRC Connection Request/RRC Resume Request (including the Cause, Session Id etc.) to the network apparatus (400). At S1312, network apparatus (400) sends the RRC Connection Setup/RRC Resume to the UE (100). At S1314, the network apparatus (400) sends the dedicated signalling (including the configuration information/Reconfiguration information) to the UE (100). At S1316, the multicast session is again active between the UE (100) and the network apparatus (400).

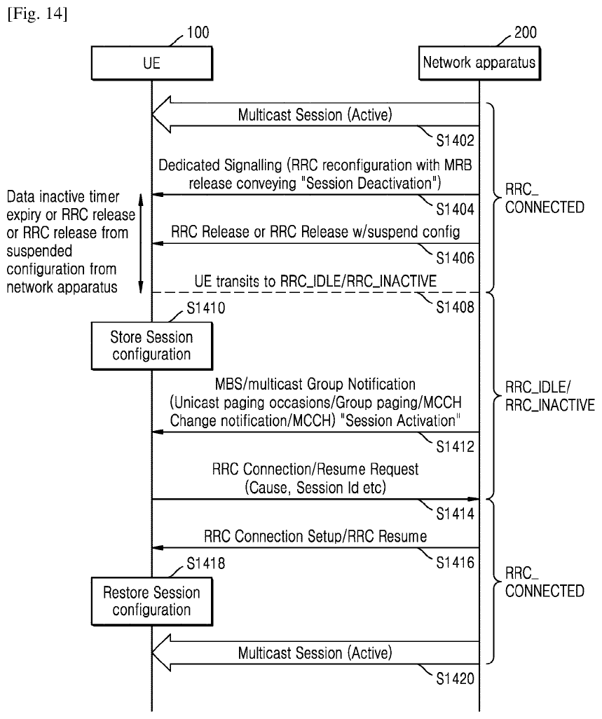

FIG. 14 is a sequence diagram illustrating a method for the multicast session notification signalling and procedure in the wireless network (1000) based on the multicast session configuration store/restore in the RRC_IDLE state or the RRC_INACTIVE state, according to the embodiments as disclosed herein.

At S1402, the multicast session is active between the UE (100) and the network apparatus (400). At S1404, the network apparatus (400) sends the dedicated signalling (including the RRC reconfiguration with the MRB release conveying “Session Deactivation”) to the UE (100). At S1406, the network apparatus (400) sends the RRC Release or RRC Release w/suspend config to the UE (100). At S1408, the UE (100) transits to the RRC_INACTIVE/RRC IDLE state, when the UE (100) determines there is the data inactivity timer expiry or the RRC release or RRC release with suspend configuration received from the network apparatus (400).

At S1410, the UE (100) stores the session configuration when UE transitions to RRC_IDLE/RRC_INACTIVE state. At S1412, network apparatus (400) sends the MBS/multicast Group Notification (including the Unicast paging occasions/Group paging/MCCH Change notification/MCCH) “Session Activation” to the UE (100). At S1414, the UE (100) sends the RRC Connection/Resume Request (including the Cause, Session Id etc) to the network apparatus (400). At S1416, network apparatus (400) sends the RRC Connection Setup/RRC Resume to the UE (100). At S1418, the UE (100) restore session configuration. At S1420, the multicast session is again active between the UE (100) and the network apparatus (400).

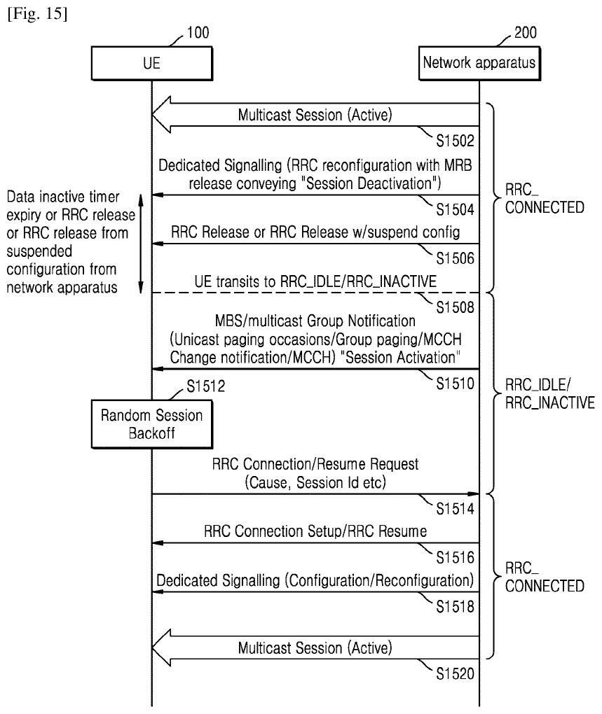

FIG. 15 is a sequence diagram illustrating a method for the multicast session notification signalling and procedure in the wireless network (1000) based on the random access back-off mechanism in the RRC_IDLE state or the RRC_INACTIVE state, according to the embodiments as disclosed herein.

At S1502, the multicast session is active between the UE (100) and the network apparatus (400). At S1504, the network apparatus (400) sends the dedicated signalling (including the RRC reconfiguration with the MRB release conveying “Session Deactivation”) to the UE (100). At S1506, the network apparatus (400) sends the RRC Release or RRC Release w/suspend config to the UE (100). At S1508, the UE (100) transits to the RRC_INACTIVE/RRC IDLE state, when the UE (100) determines there is the data inactivity timer expiry or the RRC release or RRC release with suspend configuration is received from the network apparatus (400).

At S1510, network apparatus (400) sends the MBS/multicast Group Notification (including the Unicast paging occasions/Group paging/MCCH Change notification/MCCH) “Session Activation” to the UE (100). At S1512, the UE (100) performs the random access back off. At S1514, the UE (100) sends the RRC Connection Request/RRC Resume Request (including the Cause, Session Id etc.) to the network apparatus (400). At S1516, network apparatus (400) sends the RRC Connection Setup/RRC Resume to the UE (100). At S1518, the network apparatus (400) sends the dedicated signalling (Configuration/Reconfiguration) to the UE (100). At S1520, the multicast session is again active between the UE (100) and the network apparatus (400).

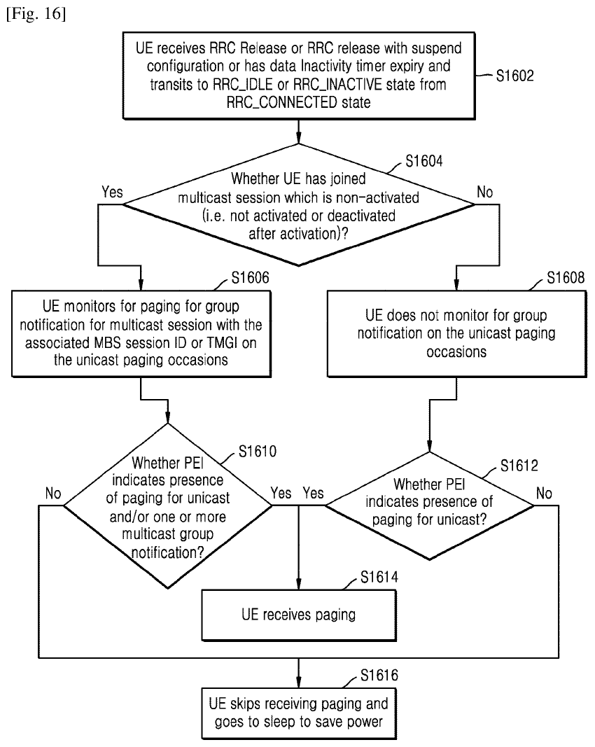

FIG. 16 is a flow chart (S1600) illustrating a method, implemented by the UE (100), for the multicast session notification signalling and procedure in the wireless network (1000) based on the Paging Early Indication (PEI) indicates presence of paging for the unicast and/or one or more multicast group notification, according to the embodiments as disclosed herein.

At S1602, the UE (100) receives the RRC Release or RRC release with the suspend configuration or has the data Inactivity timer expiry and transits to the RRC_IDLE or the RRC_INACTIVE state from the RRC_CONNECTED state. At S1604, the UE (100) determines whether the UE (100) has joined the multicast session which is non-activated (i.e., not activated or deactivated after activation).

In response to determining that the UE (100) has joined the multicast session which is non-activated then, at S1606, the UE (100) monitors for paging for the group notification for the multicast session with the associated MBS session ID or the TMGI on the unicast Paging Occasions. In response to determining that the UE (100) has not joined multicast session which is non-activated then, at S1608, the UE (100) does not monitor for the group notification on the unicast paging occasions.

At S1610, the UE (100) determines whether the PEI indicates presence of paging for unicast and/or one or more multicast group notification. At S1612, the UE (100) determines whether the PEI indicates presence of paging for unicast.

In response to determining that the PEI indicates presence of paging for unicast and/or one or more multicast group notification (as in S1610) or the PEI indicates the presence of paging for unicast (as in S1612) then, at S1614, the UE (100) receives paging. In response to determining that the PEI does not indicate the presence of paging for the unicast and/or one or more multicast group notification (as in S1610) or the PEI does not indicate the presence of paging for unicast (as in S1612) then, at S1616, the UE (100) skips receiving paging and goes to sleep to save power of the UE (100).

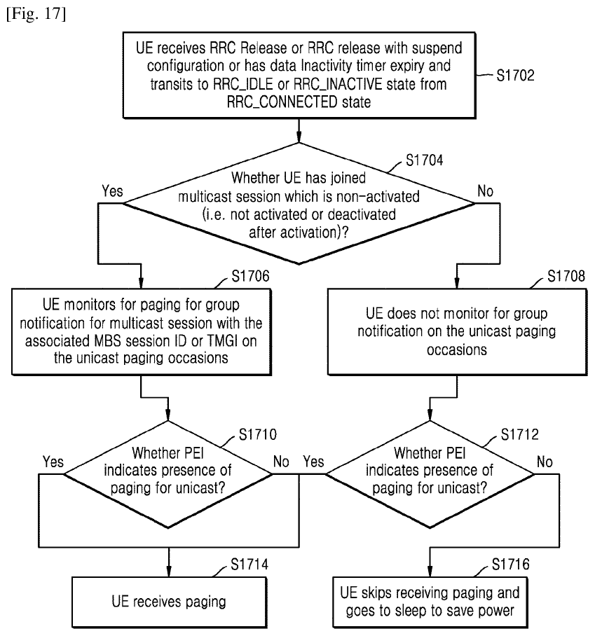

FIG. 17 is a flow chart (S1700) illustrating a method, implemented by the UE (100), for the multicast session notification signalling and procedure in the wireless network (1000) based on the PEI indicates presence of paging for the unicast, according to the embodiments as disclosed herein.

At S1702, the UE (100) receives the RRC Release or RRC release with the suspend configuration or has the data Inactivity timer expiry and transits to the RRC_IDLE or the RRC_INACTIVE state from the RRC_CONNECTED state. At S1704, the UE (100) determines whether the UE (100) has joined the multicast session which is non-activated (i.e., not activated or deactivated after activation).

In response to determining that the UE (100) has joined the multicast session which is non-activated then, at S1706, the UE (100) monitors for paging for the group notification for the multicast session with the associated MBS session ID or the TMGI on the unicast Paging Occasions. In response to determining that the UE (100) has not joined multicast session which is non-activated then, at S1708, the UE (100) does not monitor for the group notification on the unicast paging occasions.

At S1710, the UE (100) determines whether the PEI indicates presence of paging for unicast. At S1712, the UE (100) determines whether the PEI indicates presence of paging for unicast.

In response to determining that the PEI indicates presence of paging for unicast (as in S1710) or the PEI does not indicate the presence of paging for the unicast (as in S1710) or the PEI indicates the presence of paging for unicast (as in S1712) then, at S1714, the UE (100) receives paging.

In response to determining that the PEI does not indicate the presence of paging for unicast (as in S1712) then, at S1716, the UE (100) skips receiving paging and goes to sleep to save power of the UE (100).

The various actions, acts, blocks, steps, or the like in the flow charts (S300, S400, S700, S1600, and S1700) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A user equipment (UE) in a wireless communication system, the UE comprising:
a transceiver; and
a processor coupled with the transceiver and configured to:
transition from a radio resource control (RRC) connected state to an RRC idle state,
receive, from the base station, a paging message for a group notification, wherein the paging message includes a temporary mobile group identity (TMGI),
identify that the UE has joined a multicast and broadcast service (MBS) session associated with the TMGI, and
transition from the RRC idle state to the RRC connected state based on the identification.

17. The UE of claim 16, wherein the processor is further configured to monitor a paging channel for the group notification addressed with a paging radio network temporary identifier (P-RNTI).

18. The UE of claim 16, wherein the processor is further configured to, in case that the UE enters the RRC connected state, stop monitoring the paging channel for the group notification.

19. The UE of claim 16, wherein the processor is further configured to transmit, to the base station, UE capability information regarding a support for one or more group-radio network temporary identifiers (G-RNTIs) for an MBS multicast.

20. The UE of claim 16, wherein the processor is further configured to forward the TMGI to an upper layer.

21. A base station in a wireless communication system, the base station comprising:
a transceiver; and
a processor coupled with the transceiver and configured to:
transmit, to a user equipment (UE), a control message to transition the UE to a radio resource control (RRC) idle state,
transmit, to the UE, a paging message for a group notification, wherein the paging message includes a temporary mobile group identity (TMGI) and the UE has joined a multicast and broadcast service (NBS) session associated with the TMGI, and
perform, with the UE, an RRC establishment procedure.

22. The base station of claim 21, wherein the processor is further configured to transmit, to the UE, control information on a paging channel for the group notification addressed with a paging radio network temporary identifier (P-RNTI).

23. The base station of claim 21, wherein the control message to transition the UE to the RRC idle state is transmitted in case that the MBS session is deactivated.

24. The base station of claim 21, wherein the processor is further configured to receive, from the UE, UE capability information regarding a support for one or more group-radio network temporary identifiers (G-RNTIs) for an NBS multicast.

25. The base station of claim 21, wherein the TMGI is forwarded to an upper layer of the UE.

26. A method performed by a user equipment (UE) in a wireless communication system, the method comprising:
transitioning from a radio resource control (RRC) connected state to an RRC idle state;
receiving, from the base station, a paging message for a group notification, wherein the paging message includes a temporary mobile group identity (TMGI);
identifying that the UE has joined a multicast and broadcast service (MBS) session associated with the TMGI; and
transitioning from the RRC idle state to the RRC connected state based on the identification.

27. The method of claim 26, further comprising:
monitoring a paging channel for the group notification addressed with a paging radio network temporary identifier (P-RNTI); and
in case that the UE enters the RRC connected state, stopping monitoring the paging channel for the group notification.

28. A method performed by a base station in a wireless communication system, the method comprising:
transmitting, to a user equipment (UE), a control message to transition the UE to a radio resource control (RRC) idle state;
transmitting, to the UE, a paging message for a group notification, wherein the paging message includes a temporary mobile group identity (TMGI) and the UE has joined a multicast and broadcast service (MBS) session associated with the TMGI, and
performing, with the UE, an RRC establishment procedure.

29. The method of claim 28, wherein the control message to transition the UE to the RRC idle state is transmitted in case that the MBS session is deactivated.
